(19) United States
(12) Patent Application Publication
(10) Pub. No.: US 2024/0288350 A1
(43) Pub. Date: Aug. 29, 2024

(54) TWO-POINT BEND TESTING APPARATUSES AND METHODS OF USING THE SAME

(71) Applicant: CORNING INCORPORATED, CORNING, NY (US)

(72) Inventors: Nicholas Robert Bonham, Westfield, NY (US); Yu Cheng, New Taipei City (TW); Rachid Gafsi, Horseheads, NY (US); Kurt Edward Gerber, Dansville, NY (US); Paul M Giglio, Elmira, NY (US); Suresh Thakordas Gulati, Elmira, NY (US); Fang-Yu Hsu, Taichung city (TW); Te Heng Hung, Taoyuan City (TW); Weirong Jiang, Sarasota, FL (US); Cheng Yu Lai, Taichung-si (TW); Peter Joseph Lezzi, Corning, NY (US); Jody Paul Markley, JR., Watkins Glen, NY (US); Arpita Mitra, Chandler, AZ (US); Douglas Miles Noni, Horseheads, NY (US); Samuel Odei Owusu, Horseheads, NY (US); Timothy Paul Smith, Painted Post, NY (US); Ryan Christopher Sutton, Corning, NY (US); Jamie Todd Westbrook, Sayre, PA (US)

(21) Appl. No.: 18/586,507

(22) Filed: Feb. 25, 2024

Related U.S. Application Data
(60) Provisional application No. 63/448,510, filed on Feb. 27, 2023.

(51) Int. Cl. G01N 3/20; G01N 3/02

(52) U.S. Cl. CPC G01N 3/20; G01N 3/02

(57) ABSTRACT

Disclosed herein are testing apparatuses for testing stresses in substrates. The testing apparatus includes a base, a first plate coupled to the base, the first plate being movable relative to the base along a first axis, a second plate coupled to the base, the second plate being movable relative to the base and relative to the first plate along a second axis that is perpendicular to the first axis, a first actuator operable to move the first plate along the first axis towards or away from the second plate, a second actuator operable to move the second plate along the second axis relative to the first plate, and a controller operatively connected to the first actuator and the second actuator operable to control movement of the first plate and the second plate.

This application claims the benefit of priority under 35 U.S.C. § 119 of U.S. Provisional Application Ser. No. 63/448,510 filed on Feb. 27, 2023, the content of which is relied upon and incorporated herein by reference in its entirety.

### TECHNICAL FIELD

The present specification generally relates to apparatuses and methods for testing substrates and, more specifically, apparatuses and methods for two-point bend testing substrates.

### BACKGROUND

The two-point bend test has been used to determine strength and fatigue parameters of substrates. The two-point bend test involves placing a substrate between two parallel plates, with an end of the substrate attached at each of the parallel plates, and then moving the parallel plates together such that the ends of the substrate are advanced towards one another to thereby create a bent region within the substrate. This procedure may be repeated any number of times, and then the substrate may be removed and examined to see whether the substrate cracked, for example, at the bend region. The substrate is said to have passed the test if it does not exhibit any cracks or other failures.

However, existing equipment utilized to conduct the two-point bend test is only capable of subjecting a limited region of the substrate to such testing. In this manner, portions of the substrate outside of the region are not subject to the two-point bend test and may prematurely fail when in use.

Accordingly, a need exists for alternative testing apparatus for proof testing substrates in two-point bending.

### SUMMARY

According to a first aspect, an apparatus for proof-testing a substrate includes: a base; a first plate coupled to the base, the first plate being movable relative to the base along a first axis and defining a first substrate face that is oriented perpendicular to the first axis; a second plate coupled to the base, the second plate being movable relative to the base and relative to the first plate along a second axis that is perpendicular to the first axis, the second plate defining a second substrate face that is parallel to the first substrate face; a first actuator operable to move the first plate along the first axis towards or away from the second plate; a second actuator operable to move the second plate along the second axis relative to the first plate; and a controller operatively connected to the first actuator and the second actuator, wherein the controller is operable to control movement of the first plate along the first axis and to control movement of the second plate along the second axis.

A second aspect includes the apparatus of the first aspect, further including a first sensor connected to the controller for monitoring a position of the first plate along the first axis relative to the second plate.

A third aspect includes the apparatus of the second aspect, wherein the first sensor is a first linear encoder.

A fourth aspect includes the apparatus of any of the preceding aspects, further including a second sensor connected to the controller for monitoring a position of the second plate along the second axis relative to the first plate.

A fifth aspect includes the apparatus of the fourth aspect, wherein the second sensor is a second linear encoder.

A sixth aspect includes the apparatus of any of the preceding aspects, further including a plurality of openings in the first substrate face of the first plate; a plurality of openings in the second substrate face of the second plate; and a vacuum pump operably connected to the first plate and the second plate, wherein the vacuum pump is operable to apply vacuum pressure at the plurality of openings in the first substrate face of the first plate and the plurality of openings in the second substrate face of the second plate.

A seventh aspect includes the apparatus of any of the preceding aspects, wherein the first plate and the second plate each include a lower side and an upper side that is positioned farther from the base than the lower side, the first substrate face of the first plate and the second substrate face of the second plate each extending between the lower side and the upper side thereof, and wherein registration marks are provided on the upper side of the first plate and on the upper side of the second plate.

An eighth aspect includes the apparatus of any of the preceding aspects, wherein the first plate and the second plate each include a lower side and an upper side that is positioned farther from the base than the lower side, the first substrate face of the first plate and the second substrate face of the second plate each extending between the lower side and the upper side thereof, wherein a first clamp is provided on the upper side of the first plate and a second clamp is provided on the upper side of the second plate.

A ninth aspect includes the apparatus of any of the preceding aspects, further including an acoustic sensor operably connected to the controller and operable to detect sound associated with a failure of the substrate, and a camera operably connected to the controller and operable capture an image of the failure of the substrate, wherein the controller is operable to cease operation of the first actuator and the second actuator upon detection of the failure of the substrate.

A tenth aspect includes the apparatus of any of the preceding aspects, further including a first sacrificial film removably disposed on the first substrate face of the first plate and a second sacrificial film removably disposed on the second substrate face of the second plate.

According to an eleventh aspect, an apparatus for testing a substrate includes a base; a first plate coupled to the base, the first plate being movable relative to the base along a first axis and along a second axis that is perpendicular to the first axis, the first plate defining a first substrate face that is oriented perpendicular to the first axis; a second plate coupled to the base, the second plate being movable relative to the base and relative to the first plate along the first axis and along a third axis that is parallel to the second axis, the second plate defining a second substrate face that is parallel to the first substrate face; a first actuator operable to move the first plate along the first axis towards or away from the second plate; a second actuator operable to move the first plate along the second axis relative to the second plate; a third actuator operable to move the second plate along the first axis towards or away from the first plate; a fourth actuator operable to move the second plate along the third axis relative to the second plate; and a human machine interface, the human machine interface comprising a controller and a display, wherein the controller is operatively connected to the first actuator, the second actuator, the third actuator, and the fourth actuator to control movement of the first plate along the first axis and the second axis and to control movement of the second plate along the first axis and the third axis

A twelfth aspect includes the apparatus of the eleventh aspect, further including a plurality of openings in the first substrate face and in the second substrate face and a vacuum pump operably connected to the first plate and the second plate, wherein the vacuum pump is operable to apply vacuum pressure at the plurality of openings.

A thirteenth aspect includes the apparatus of the twelfth aspect, wherein the first substrate face comprises a central channel associated with each opening formed therein, each of the central channels being in communication with the opening associated therewith and having a plurality of grooves extending therefrom, each of the grooves and each of the plurality of grooves being formed in the first substrate face such that vacuum pressure supplied by the opening is applied to the central channel and the plurality of grooves to thereby retain a first end of the substrate when covering the central channel and the plurality of grooves; and the second substrate face comprises a central channel associated with each opening formed therein, each of the central channels being in communication with the opening associated therewith and having a plurality of grooves extending therefrom, each of the grooves and each of the plurality of grooves being formed in the second substrate face such that vacuum pressure supplied by the opening is applied to the central channel and the plurality of grooves to thereby retain a second end of the substrate when covering the central channel and the plurality of grooves.

A fourteenth aspect includes the apparatus of any of the eleventh through the thirteenth aspects, wherein the first plate and the second plate each include a lower side and an upper side that is positioned further from the base than the lower side, the first substrate face of the first plate and the second substrate face of the second plate each extending between the lower side and the upper side thereof, and wherein registration marks are provided on the upper side of the first plate and on the upper side of the second plate.

A fifteenth aspect includes the apparatus of any of any of the eleventh through the fourteenth aspects, wherein the first plate and the second plate each include a lower side and an upper side that is positioned further from the base than the lower side, the first substrate face of the first plate and the second substrate face of the second plate each extending between the lower side and the upper side thereof, and a first clamp is provided on the upper side of the first plate and a second clamp is provided on the upper side of the second plate.

A sixteenth aspect includes the apparatus of any of the eleventh through the fifteenth aspects, further including an acoustic sensor operably connected to the controller and operable to detect sound associated with a failure of the substrate.

A seventeenth aspect includes the apparatus of the sixteenth aspect, further including a camera operably connected to the controller and operable to capture an image of the failure of the substrate.

An eighteenth aspect includes the apparatus of the seventeenth aspect, wherein the controller is operable to record the image of the failure of the substrate upon detecting the failure via the acoustic sensor.

A nineteenth aspect includes the apparatus of the eighteenth aspect, wherein the first plate and the second plate each include a lower side and an upper side that is positioned further from the base than the lower side, the first substrate face of the first plate and the second substrate face of the second plate each extending between the lower side and the upper side thereof, and at least one scale feature disposed on either or both of the first plate and the second plate, the at least one scale feature having a known dimension and positioned in view of the camera.

A twentieth aspect includes the apparatus of any of the eleventh through the nineteenth aspects, further including a first sacrificial film removably disposed on the first substrate face of the first plate and a second sacrificial film removably disposed on the second substrate face of the second plate.

According to a twenty-first aspect, method of testing a substrate includes: attaching a first end of the substrate to a first plate and a second end of the substrate to a second plate, wherein the first plate and the second plate are parallel; moving, via a first actuator, the first plate along a first axis from a first default position towards the second plate into a first testing position, where a first substrate face of the first plate is positioned at a first desired spacing from a second substrate face of the second plate, wherein the first desired spacing is at least partially based on material properties of the substrate and design parameters of the substrate; and translating, via a second actuator, the second plate relative to the first plate along a second axis that is perpendicular to the first axis from a second default position.

A twenty-second aspect includes the method of the twenty-first aspect, further including calculating the first desired spacing based at least on material properties of the substrate and design parameters of the substrate.

A twenty-third aspect includes the method of any of the twenty-first through twenty-second aspects, wherein the moving the second plate comprises moving the second plate a prescribed distance in a first direction from the second default position, returning the second plate to the second default position, continue moving the second plate the prescribed distance from the second default position along the second axis in a second direction where the second direction is opposite the first direction, and returning the second plate to the second default position.

A twenty-fourth aspect includes the method of any of the twenty-first through twenty-third aspects, further including: returning the first plate, via the first actuator, to the first default position; and returning the second plate, via the second actuator, to the second default position.

A twenty-fifth aspect includes the method of any of the twenty-first through twenty-fourth aspects, further including translating, via a third actuator, the first plate relative to the second plate along a third axis that is parallel to the second axis as the second plate is translated along the second axis, wherein the first plate is translated along the third axis in an opposite direction as the second plate and at an equal speed as the second plate.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A schematically depicts a front view a testing apparatus for proof testing substrates, according to one or more embodiments shown and described herein;

FIG. 1B schematically depicts a rear view of the testing apparatus of FIG. 1A;

FIG. 2A schematically depicts a side view of a portion of the testing apparatus of FIGS. 1A and 1B;

FIG. 2B schematically depicts a side view of a portion of the testing apparatus of FIGS. 1A and 1B;

FIG. 3 depicts upper sides of a first plate and a second plate of the testing apparatus of FIGS. 1A and 1B;

FIG. 4 illustrates a substrate loaded in the testing apparatus of FIGS. 1A and 1B and attached to the first plate and the second plate, according to one or more embodiments of the present disclosure;

FIG. 5A is a close up front view of a portion of the testing apparatus of FIGS. 1A and 1B;

FIG. 5B is a close up rear view of a portion of the testing apparatus of FIGS. 1A and 1B;

FIG. 6 schematically depicts an alternative embodiment of a testing apparatus for proof-testing substrates, according to one or more embodiments shown and described herein;

FIG. 7A schematically depicts a plate of the testing apparatus of FIG. 6 having a plurality of vacuum zones, according to one or more embodiments shown and described herein;

FIG. 7B schematically depicts a detailed view of a region of the plate of FIG. 7A;

FIG. 7C schematically depicts a perspective view of a portion of the plate of FIG. 7A;

FIG. 8 is a flow chart of a method of testing a substrate, according to one or more embodiments shown and described herein; and

FIG. 9 is a flow chart of an alternative method of testing a substrate, according to one or more embodiments shown and described herein.

### DETAILED DESCRIPTION

Embodiments described herein are directed to testing apparatuses that include a first plate and a second plate between which a substrate may be attached, wherein the first plate and the second plate are movable towards each other along a first axis to create a bend in a region of the substrate and translatable relative to each other along a second axis that is perpendicular to the first axis to reposition the bend in the substrate to other regions of the substrate, thereby subjecting a larger area of the substrate to stresses associated with the bend. For example, when moving the first plate and the second plate together to form the bend in the substrate, the region of the substrate subjected to bending is approximately 2% to 5% of a length of the substrate; however, by further translating the first plate and/or the second plate relative to each other, the bend region of the substrate may shift along the length of the substrate such that up to about 80% of the substrate may be subjected to bending. Thus, a longer or larger portion of the substrate may be exposed to the desired stress, thereby enhancing the ability to find flaws or defects in the substrate.

Various embodiments of the apparatus and method and the operation of the apparatus and method are described in more detail herein. Whenever possible, the same reference numerals will be used throughout the drawings to refer to the same or like parts.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

The term “substrate,” as used herein, refers to substrates that may be formed from glass, glass-based ceramics, or ceramics.

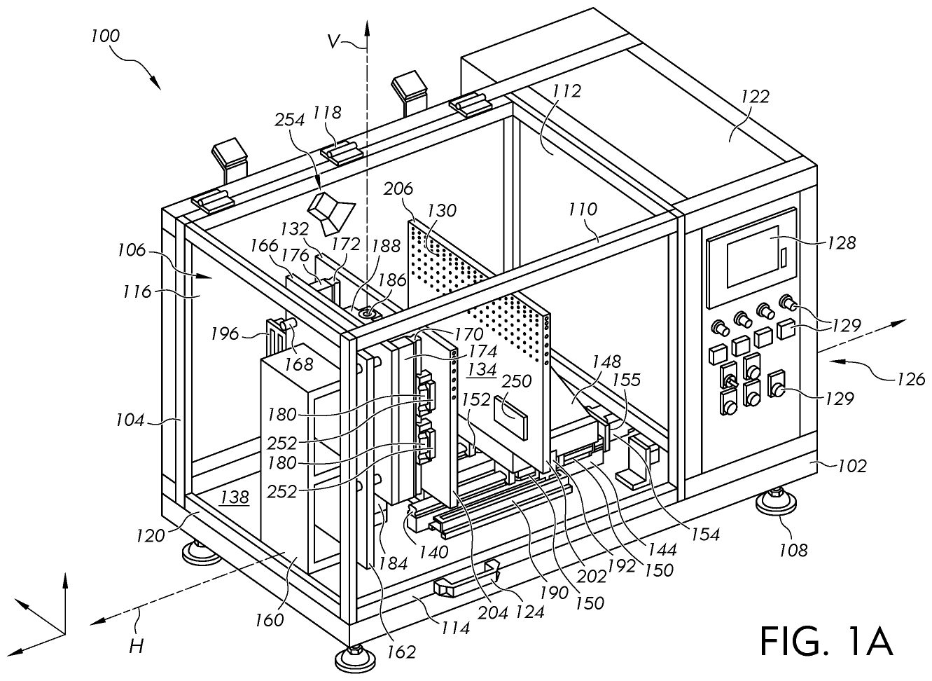

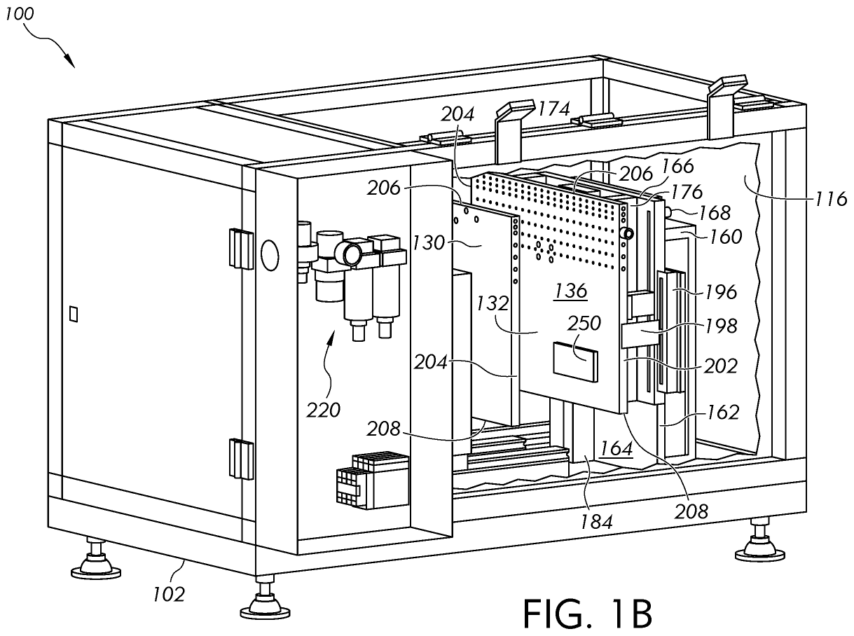

Referring now to FIGS. 1A and 1B, a testing apparatus 100 is schematically depicted according to one or more embodiments described herein. The testing apparatus 100 (hereinafter, the “apparatus 100”) may generally include a base 102 and a housing 104 provided on an upper side of the base 102. FIG. 1A is a perspective front view of the apparatus 100, whereas FIG. 1B is a perspective rear view of the apparatus 100. As hereinafter described, the housing 104 at least partially defines and encloses a testing cavity 106 of the apparatus 100. A plurality of feet 108 may be provided on a lower side of the base 102, and the plurality of feet 108 may be adjustable so as to adjust the attitude orientation of the apparatus 100. For example, the plurality of feet 108 may be rotated relative to the base 102 so as to position the base 102 in a substantially horizontal orientation.

In the illustrated embodiment, the housing 104 comprises a door 110 that includes a top panel 112 and a front sidewall 114 of the housing 104. Here, the door 110 is connected to a rear sidewall 116 of the housing 104 via a plurality of hinges 118. Thus, the door 110 is movable between a closed position, where the door 110 encloses the testing cavity 106 as shown in FIGS. 1A and 1B, and an open position, where the testing cavity 106 is uncovered by the door 110 and exposed to the external ambient environment. In the illustrated example, the housing 104 further includes a sidewall 120 that remains stationary when opening or closing the door 110. Thus, when the door 110 is moved into the open position, the testing cavity 106 is uncovered and accessible from a front side and from a top side of the apparatus 100. However, in some embodiments, the door 110 also includes at least a portion of the sidewall 120 so as to expose the testing cavity 106 from that side when moved into the open position.

Also, in the illustrated embodiment, the apparatus 100 also includes an electronics housing 122 which encloses the various electronics and controls of the apparatus 100 described herein. As shown, the electronics housing 122 is provided at a right side of the apparatus 100, opposite the sidewall 120, and also partially encloses the testing cavity 106. Thus, the testing cavity 106 is defined between the top panel 112, the front sidewall 114, the rear sidewall 116, the sidewall 120, and the electronics housing 122. However, it will be appreciated that the housing 104 and the electronics housing 122 may be differently provided, for example, with the electronics housing 122 being provided at the left side of the apparatus 100 and with a right sidewall provided at the right side of the apparatus 100 so as to constrain the testing cavity 106 from the left and right sides, respectively.

At least a portion of the housing 104 may include a transparent material, such as glass or plastic, such that the testing cavity 106 is visible through the housing 104. In the illustrated example, the top panel 112, the front sidewall 114 and the sidewall 120 of the housing 104 are each at least partially comprised of a transparent material, whereas the rear sidewall 116 is comprised of a non-transparent material, such as a metal. However, the rear sidewall 116 may be similarly comprised of a transparent material. In other embodiments, transparent material is provided only on the door 110 or on a portion of the door 110. Also, one or more handles 124 may be provided on the door 110 for facilitating opening and closing of the door 110.

The apparatus 100 includes a human machine interface 126 for controlling operation of the apparatus 100. The human machine interface 126 (hereinafter, the “HMI 126”) may comprise a controller, a memory and other electronics for controlling operation of the apparatus 100 and carrying out a two-point bend test, and one or more components of the HMI 126 may be contained within the electronics housing 122. In embodiments, the memory may store computer readable instructions that are executed by the controller. In the illustrated embodiment, the HMI 126 further includes a display 128 and a plurality of user inputs 129 (e.g., buttons, switches, knobs, dials, etc.) provided on an exterior of the electronics housing 122. The display 128 visually outputs test data and/or operating parameters, and the plurality of user inputs 129 allow the user to set or adjust one or more operating parameters, one or more material properties of the substrate, and/or one or more design parameters of the substrate. For example, the memory may be programmed to calculate a parallel plate spacing at which the substrate should be proof tested based on material properties of the substrate and design parameters of the substrate and the user may further select certain operating parameters at which such proof testing shall occur, such as number of cycles, duration of test, etc.

The HMI 126 may also include visual indicators (e.g., LEDs) and/or speakers for providing audio feedback to the operator concerning operation of a two-point bend test and or operating parameters. In the illustrated embodiment, the HMI 126 is provided at a front of the apparatus 100. However, the HMI 126 may be provided elsewhere about the apparatus 100, for example on a top side thereof and/or at a side thereof. In embodiments, the HMI 126 is configured to communicate with a remote device (not shown). The remote device may be a remote controller, a computer, a mobile telephone, etc., which is positioned remote from the apparatus 100. In this manner, the apparatus 100 may be remotely controlled and monitored.

The apparatus 100 includes a first plate 130 and a second plate 132 movably provided within the testing cavity 106. The first plate 130 is movable relative to the second plate 132 along a horizontal axis H, which is parallel to an X direction of the coordinate axes depicted in FIG. 1, and the second plate 132 is movable relative to the first plate 130 along vertical axis V, which is parallel to a Y direction of the coordinate axes depicted in FIG. 1. As described in further detail herein, the first plate 130 may be moved along the horizontal axis H towards the second plate 132 to form a bend in a substrate, and then the second plate 132 may be moved along the vertical axis V relative to the first plate 130 so as to reposition the bend in the substrate, such that a larger region of the substrate is subject to bending.

The first plate 130 and the second plate 132 are parallel to each other. More specifically, a substrate face 134 of the first plate 130 is parallel to a substrate face 136 of the second plate 132. To maintain parallelism between the substrate face 134 and the substrate face 136, the first plate 130 and the second plate 132 may each be made of a metal, such as iron or steel, and then substrate face 134 of the first plate 130 and the substrate face 136 of the second plate 132 may each be machined to be substantially flat, for example, surface grinding and polishing the surfaces to a flatness of less than 0.02 millimeters (“mm”). In such examples, upon installing the first plate 130 and the second plate 132 within the apparatus 100 as hereinafter described, the parallelism between the substrate face 134 of the first plate 130 and the substrate face 136 of the second plate 132 may be less than about 0.1 mm. However, the substrate faces 134, 136 may have different flatness and/or parallelism values depending on the desired radius of the bend to be formed in the substrate. After being installed in the apparatus 100, parallelism between the substrate face 134 and the substrate face 136 may be periodically measured via a coordinate measuring machine (CMM).

The first plate 130 and the second plate 132 are each movably disposed on an upper surface 138 of the base 102. With regard to the first plate 130, a pair of rails 140, 142 are provided on the upper surface 138 of the base 102. Each of the pair of rails 140, 142 extends in a direction that is parallel to the horizontal axis H. In the illustrated embodiment, a pair of risers 144, 146 are mounted to the upper surface 138 of the base 102 and the pair of rails 140, 142 are each provided on its respective one of the pair of risers 144, 146, such that the pair of rails 140, 142 are each spaced apart from the upper surface 138 of the base 102. The pair of risers 144, 146 also each extend in the direction parallel to the horizontal axis H. While the illustrated embodiment shows the first plate 130 being slidable upon the pair of rails 140, 142, more or less than two rails may be provided to permit sliding of the first plate 130 without departing from the present disclosure.

In addition, the first plate 130 includes a chassis 148 that supports the first plate 130 and is configured to slide along the pair of rails 140, 142. In particular, the chassis 148 supports the first plate 130 such that orientation of the substrate face 134 is maintained as desired. For example, the chassis 148 supports the first plate 130 such that the substrate face 134 thereof is parallel to the substrate face 136 of the second plate 132. In the illustrated embodiment, the chassis 148 slides on the pair of rails 140, 142 via a pair of sliders 150, 152 that are attached to a lower surface (obscured from view) of the chassis 148. The pair of sliders 150, 152 are slidably coupled to the pair of rails 140, 142, such that the chassis 148 is movable along the pair of rails 140, 142. Accordingly, the first plate 130 supported on the chassis 148 is movable along the pair of rails 140, 142 in a first direction towards the second plate 132 or in a second direction away from the second plate 132.

The apparatus 100 includes a first actuator 154 operable to move the first plate 130 towards or away from the second plate 132. The first actuator 154 is communicatively coupled to the HMI 126, for example, operatively connected to the controller thereof, such that a user may control operation of the first actuator 154 or such that the first actuator 154 may be automatically controlled via a pre-programmed routine. In embodiments, the first actuator 154 is a servo motor. However, the first actuator 154 may comprise different types of motors without departing from the present disclosure, such as a stepper motor, a linear actuator, etc.

The first actuator 154 is fixed relative to the base 102. In some embodiments, the first actuator 154 is mounted directly on the upper surface 138 of the base 102. In the illustrated embodiment, the first actuator 154 is attached to the pair of risers 144, 146 via a bracket 155 that positions and supports the first actuator 154 between the pair of risers 144, 146.

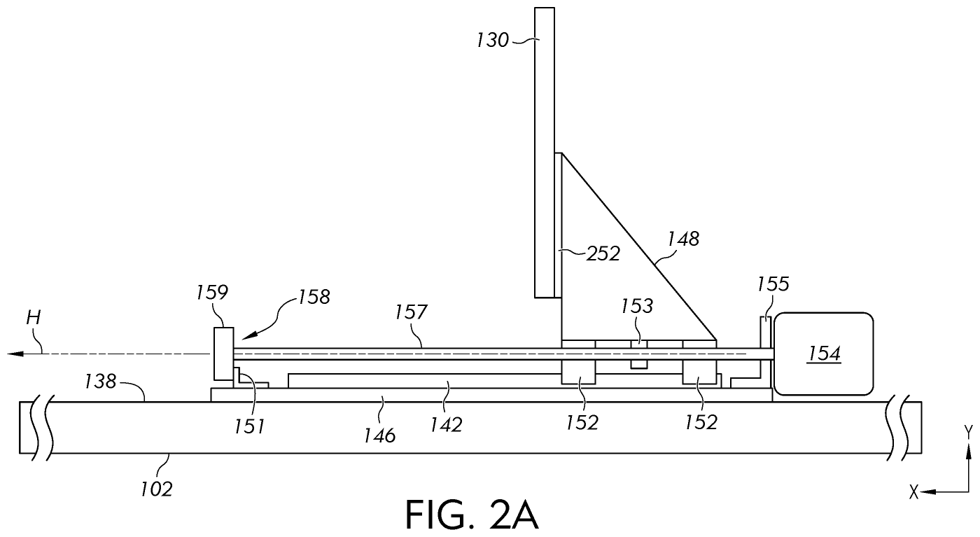

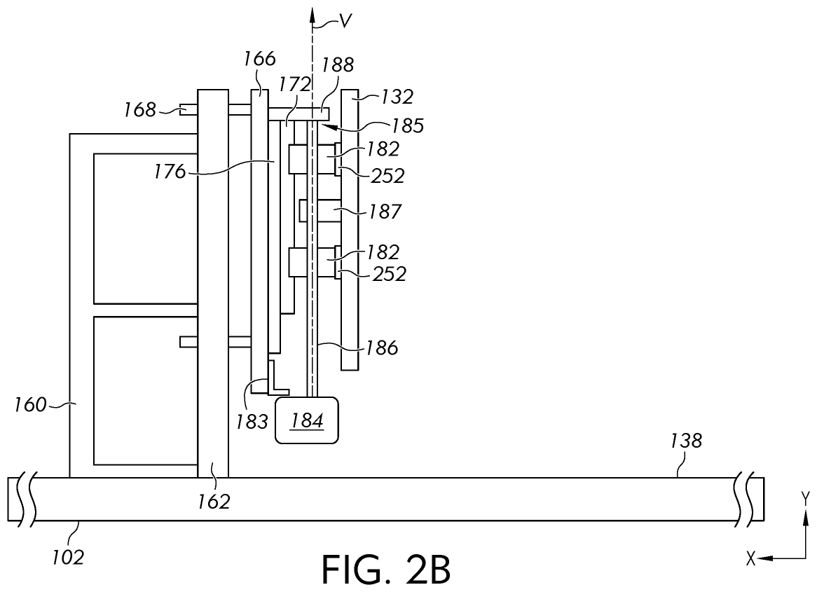

Referring now to FIG. 2A, a cross-section of a portion of the apparatus 100 in the plane defined by the horizontal axis H and the vertical axis V is schematically illustrated. In particular, FIG. 2A depicts a side view of the first actuator 154 driving the first plate 130 along the horizontal axis H. Here, the first actuator 154 includes a drive screw 157 that is rotatable (clockwise or counter-clockwise) via actuation of the first actuator 154. The drive screw 157 includes a thread on an outer surface of the drive screw 157, and the drive screw 157 extends from the first actuator 154, along the horizontal axis H, and terminates at a free end 158. In embodiments, the free end 158 of the drive screw 157 of the first actuator 154 is supported by a bearing 159. The bearing 159 is fixed relative to the base 102. In embodiments, the bearing 159 is attached to the riser 146 via a bracket 151 that positions and supports the bearing 159 opposite the first actuator 154. In other embodiments, the bearing 159 may be mounted directly on the upper surface 138 of the base 102.

A drive nut 153 is attached to the chassis 148. The drive nut 153 includes a threaded bore (obscured from view) that meshes with the thread of the drive screw 157. In the illustrated embodiment, the drive nut 153 is attached to the lower surface of the chassis 148. The drive nut 153 is arranged on the drive screw 157, with the threaded bore of the drive nut 153 engaging the thread of the drive screw 157, such that rotation of the drive screw 157 translates the drive nut 153, and such translation of the drive nut 153 correspondingly moves the chassis 148 and the first plate 130 in either direction along the horizontal axis H. Accordingly, the first actuator 154 is operable to move the first plate 130 in a first direction along the horizontal axis H or a second direction along the horizontal axis H that is opposite the first direction, with the first direction being oriented towards the second plate 132 and the second direction being oriented away from the second plate 132.

Referring again to FIGS. 1A and 1B, the second plate 132 is suspended within the testing cavity 106 such that the substrate face 136 thereof is oriented parallel to the substrate face 134 of the first plate 130, and such that the second plate 132 is movable along the vertical axis V while maintaining parallelism between the substrate face 134 of the first plate 130 and the substrate face 136 of the second plate 132.

In the illustrated embodiment, the apparatus 100 includes a support frame 160 and a mounting plate 162 attached to the support frame 160. The support frame 160 is attached to the upper surface 138 of the base 102 and extends upward therefrom in a direction corresponding with the Y direction of the depicted coordinate axes. The mounting plate 162 is attached to a side of the support frame 160 that faces the first plate 130. In this manner, the support frame 160 orients the mounting plate 162 such that a mounting surface 164 of the mounting plate 162 faces the substrate face 134 of the first plate 130. A positioning plate 166 is suspended on the mounting plate 162 via a plurality of pins 168. In embodiments, each of the plurality of pins 168 is a threaded pin that is rotatably connected to the positioning plate 166 and extends through a correspondingly threaded bore of the mounting plate 162, such that orientation of the positioning plate 166 may be adjusted relative to the mounting plate 162 via rotation of any one or more of the plurality of pins 168. In this manner, orientation of the substrate face 136 of the second plate 132 may be adjusted and fine-tuned, for example, so as to maintain and/or adjust parallelism with the substrate face 134 of the first plate 130. For example, the plurality of pins 168 may be utilized to adjust orientation of the substrate face 136 to maintain a desired amount of parallelism with the substrate face 134 of the first plate 130. In embodiments, orientation of the first plate 130 may be similarly adjusted, as described with reference to the plurality of pins 168 and the second plate 132.

A first rail 170 and a second rail 172 are provided on the positioning plate 166. The first rail 170 and the second rail 172 each extends in a direction that is parallel to the vertical axis V. In the illustrated embodiment, a first riser 174 and a second riser 176 are mounted on a surface of the positioning plate 166 that faces a rear surface 178 of the second plate 132, with the first rail 170 provided on the first riser 174 and the second rail 172 provided on the second riser 176, such that the first rail 170 and the second rail 172 are each spaced apart from the surface of the positioning plate 166. The first riser 174 and the second riser 176 also each extend in the direction parallel to the vertical axis V. While the illustrated embodiment utilizes the second plate 132 being slidable upon the first rail 170 and the second rail 172, more or less rails may be provided without departing from the present disclosure.

In the illustrated embodiment, the second plate 132 slides on the first rail 170 and the second rail 172 via a first slider 180 and a second slider 182 (see FIG. 2B), respectively, that are attached to the rear surface 178 of the second plate 132. While FIG. 1A depicts the first slider 180 slidably coupling the second plate 132 to the first rail 170, the second slider 182 that slidably couples the second plate 132 to second rail 172 is obscured from view in FIGS. 1A and 1B, and it should be appreciated that the second slider 182 may be provided in a similar manner as with the first slider 180. The second slider 182 is schematically depicted in FIG. 2B, which is a cross-section of a portion of the apparatus 100 in the plane defined by the horizontal axis H and the vertical axis V. In the illustrated embodiment, the first slider 180 and the second slider 182 each comprise a pair of vertically spaced sliders. However, in other embodiments, the first slider 180 and/or the second slider 182 may each comprise a single slider or more than two sliders.

The first slider 180 and the second slider 182 are slidably coupled to the first rail 170 and the second rail 172, respectively, such that the second plate 132 is movable along the vertical axis V in a first direction or a second direction that is opposite the first direction, where the second plate 132 moves away from the base 102 when moved in the first direction and the second plate 132 moves towards the base 102 when moved in the second direction. Thus, the second plate 132 is movable perpendicular to the movement of the first plate 130. As hereinafter described, during a two-point bend test, the second plate 132 may be located at a default location along the vertical axis Vas the first plate 130 is moved towards the second plate 132, and then the second plate 132 may be moved a prescribed distance in the first direction (away from the base 102) into an upper test position, then moved in the second direction (towards from the base 102) back into the default position and continue being moved in the second direction for the prescribed distance into a lower test position, and then moved in the first direction back into the default position. The second plate 132 may undergo any number of movement cycles during the two-point bend test, wherein each of the movement cycles comprises moving the second plate 132, from the default position, into the upper test position and then into the lower test position, and then back into the default position. Also, while the apparatus 100 is described herein as being configured to allow translation of the second plate 132 along the vertical axis V, in other embodiments, both the first plate 130 and the second plate 132 may be configured to translate parallel to the Y direction of the depicted coordinate axes.

In addition, the apparatus 100 includes a second actuator 184 operable to move the second plate 132, relative to the first plate 130 and perpendicular to the motion of the first plate 130. Similar to the first actuator 154, the second actuator 184 is connected to the HMI 126, for example, operatively connected to the controller thereof, such that a user may control operation of the second actuator 184 or such that the second actuator 184 may be automatically controlled via a pre-programmed routine. In embodiments, the second actuator 184 is a servo motor. However, the second actuator 184 may comprise different types of motors without departing from the present disclosure.

Referring to FIG. 2B, the second actuator 184 includes a drive screw 186 that is rotatable (clockwise or counter-clockwise) via actuation of the second actuator 184, similar to the first actuator 154. The second actuator 184 is positioned such that the drive screw 186 extending therefrom is oriented between the first riser 174 and the second rail 172 and, therefore, between the first rail 170 and the second rail 172, as shown in FIG. 1A. In the illustrated embodiment, the second actuator 184 is supported by the positioning plate 166 and fixed relative thereto. As depicted in FIG. 2B, the second actuator 184 is coupled to the surface of the positioning plate 166 (i.e., the surface of the positioning plate 166 that faces the rear surface 178 of the second plate 132) via a bracket 183. The second actuator 184 may be differently mounted, however. For example, in other embodiments, the second actuator 184 is attached directly to the surface of the positioning plate 166, the second actuator 184 is mounted directly on the upper surface 138 of the base 102, or the second actuator 184 is attached to the mounting surface 164 of the mounting plate 162.

The drive screw 186 extends from the second actuator 184, along the vertical axis V, and the drive screw 186 terminates at a free end 185 that is rotatably supported in a bearing 188. Here, the bearing 188 is also mounted to the surface of the positioning plate 166 (i.e., the surface of the positioning plate 166 that faces the rear surface 178 of the second plate 132) at a location thereon between the first riser 174 and the second rail 172 and opposite the second actuator 184, as shown in FIG. 1A.

As shown in FIG. 2B, a drive nut 187 is attached to the second plate 132. The drive screw 186 includes a thread on an external surface thereof, and the drive nut 187 includes a threaded bore that meshes with the thread of the drive screw 186. In the illustrated embodiment, the drive nut 187 is attached to the rear surface 178 of the second plate 132. The drive nut 187 is arranged on the drive screw 186, with the threaded bore of the drive nut 187 engaging the thread of the drive screw 186, such that rotation of the drive screw 186 translates the drive nut 187, and such translation of the drive nut 187 correspondingly moves the second plate 132 in either direction along the vertical axis V. Accordingly, the second actuator 184 is operable to move the second plate 132 in the first direction along the vertical axis V or the second direction along the vertical axis V as described above.

Referring again to FIGS. 1A and 1B, when conducting the two-point bend test, a bend is formed in the substrate and the response of the substrate to such bending is evaluated. The bend is defined by a radius, and the radius may be selected based on the particular end use in which the substrate is intended to be utilized. To form the bend with the radius, a first end of the substrate is attached to the first plate 130 and a second end of the substrate is attached to the second plate 132, and then the first plate 130 is moved towards the second plate 132 a determined distance to create a desired spacing between the substrate face 134 of the first plate 130 and the substrate face 136 of the second plate 132. Stated differently, the first plate 130 is moved towards the second plate 132 until the desired spacing exists between the substrate face 134 of the first plate 130 and the substrate face 136 of the second plate 132. It should be appreciated, however, that while the first plate 130 may be moved the determined distance along the horizontal axis H to establish the desired spacing between the substrate face 134 and the substrate face 136 and that such movement of the first plate 130 will thereby form the bend in the substrate having the radius as desired, an amount equal to twice the radius may nevertheless be smaller than the desired spacing between the substrate face 134 and the substrate face 136, and that such variance is due to the thickness of the substrate. Thus, while the desired spacing between the substrate face 134 and the substrate face 136 may be slightly larger than twice the bend radius desired to be tested, moving the first plate 130 to establish the desired spacing will nevertheless result in bending the substrate with the radius as desired. Accordingly, the apparatus 100 is operable to determine a distance between the substrate face 134 of the first plate 130 and the substrate face 136 of the second plate 132, such that the first actuator 154 may be activated to move the first plate 130 to establish the desired spacing. In addition, the apparatus 100 is operable to determine a distance that the second plate 132 travels, relative to the first plate 130, such that the second actuator 184 may be activated to move the second plate 132 as desired in a particular test.

Referring to FIG. 1A, in embodiments, the apparatus 100 includes a first linear encoder 190 that may be utilized to establish the desired spacing between the substrate face 134 of the first plate 130 and the substrate face 136 of the second plate 132. As detailed below, the HMI 126 is operable to determine spacing or distance between the substrate face 134 and the substrate face 136 via data received from the first linear encoder 190. In the illustrated embodiment, the first linear encoder 190 is mounted on the upper surface 138 of the base 102, and is oriented such that it extends along the pair of rails 140, 142. Here, a tag 192 is attached on the chassis 148 and the tag 192 extends into a slot of the first linear encoder 190 such that the first linear encoder 190 may read the tag 192. Because the tag 192 is fixed to the chassis 148, the distance or spacing between the tag 192 and the substrate face 134 of the first plate 130 measurable along the horizontal axis H is fixed and may be determined or known. Stated differently, a location of the substrate face 134 is associated with a location of the tag 192 in the slot of the first linear encoder 190.

The first linear encoder 190 generates position data indicative of the location of the tag 192 along the horizontal axis H, and the first linear encoder 190 is communicatively coupled to the HMI 126, for example, the controller thereof, such that the position data of the tag 192 is transmitted to the HMI 126. As described herein, the relative distance between the tag 192 and the substrate face 134 of the first plate 130 as measured along the horizontal axis H is known, and that known relative distance may be programmed into the HMI 126 such that the HMI 126 is operable to calculate, using the position data of the tag 192, the location of the substrate face 134 of the first plate 130 along the horizontal axis H. Also, the location of the substrate face 136 of the second plate 132 along the horizontal axis H may be programmed into the HMI 126, such that the HMI 126 is operable to calculate the spacing between the substrate face 134 and the substrate face 136. Using this information, the HMI 126 may control operation of the first actuator 154 to move the first plate 130 a sufficient amount to establish the desired spacing between the substrate face 134 and the substrate face 136. In embodiments, the first actuator 154 and the first linear encoder 190 may be provided as a closed-loop feedback control system such that the first actuator 154 is operable to position the first plate 130 at a location where the spacing between the substrate face 134 and the substrate face 136 is equal to the desired spacing.

Referring to FIG. 1B, in embodiments, the apparatus 100 also includes a second linear encoder 196 utilizable for controlling how far the second plate 132 travels along the vertical axis V, from a default position, in the first direction away from the base 102 and in the second direction towards the base 102. In the illustrated embodiment, the second linear encoder 196 is mounted to the positioning plate 166, for example, via a bracket that positions the second linear encoder 196 proximate to the second rail 172 and the second riser 176. Here, the second linear encoder 196 is oriented such that it extends in a direction parallel to the vertical axis V and along the second rail 172 and the second riser 176. Also, a tag 198 is attached to the second plate 132 and the tag 198 extends into a slot of the second linear encoder 196 such that the second linear encoder 196 may read or sense the tag 198, wherein the slot of the second linear encoder 196 extends in a direction parallel to the vertical axis V. The tag 198 may be positioned at various locations on the second plate 132 and the second linear encoder 196 may be positioned at various locations on the positioning plate 166; however, regardless of where the tag 198 and the second linear encoder 196 are mounted, they may be positioned relative to each other such that the tag 198 extends into a center point of the slot of the second linear encoder 196 when the second plate 132 is in the default position. Thus, the second linear encoder 196 and/or the tag 198 thereof are positioned such that the tag 198 extends into the center point of the slot of the second linear encoder 196 when the second plate 132 is in the default position. In this manner, the second linear encoder 196 may generate position data indicative of how far the tag 198 has moved, from the center point, in the first direction away from the base 102 or in the second direction towards the base 102.

As with the first linear encoder 190, the second linear encoder 196 is also communicatively coupled to the HMI 126, for example, operatively connected to the controller thereof, such that the position data of the tag 198 is transmitted to the HMI 126. The position data of the tag 198 correlates to how far the second plate 132 travels, from the default position, in either the first direction or the second direction. As described herein, during a two-point bend test, a test parameter may require that the second plate 132 be moved in the first direction for the prescribed distance into the upper test position and/or be moved in the second direction for the prescribed distance into the lower test position. The HMI 126 may utilize the position data of the tag 198 to properly move the second plate 132 into the upper test position and/or the lower test position. For example, the HMI 126 may monitor the position data of the tag 198 as the second actuator 184 moves the second plate 132 along the vertical axis V in either the first direction or the second direction, and may cease operation of the second actuator 184 the position data of the tag 198 indicates that the second plate 132 has traveled a distance that is equal to the prescribed distance established by the test parameter or protocol. In embodiments, the second actuator 184 and the second linear encoder 196 may be provided as a closed-loop feedback control system such that the second actuator 184 is operable to move the second plate 132 along the vertical axis V for the prescribed distance in either the first direction or second direction. Also, a test parameter may require that the second plate 132 undergo a certain number of movement cycles, and the HMI 126 is operable carry out the movement cycles established by the test parameter.

The first linear encoder 190 and the second linear encoder 196 are thus operable to determine the travel distance of the first plate 130 and the second plate 132, respectively. The apparatus 100 may have one or more sensors in addition to or in lieu of the first linear encoder 190 and/or the second linear encoder 196. In embodiments, a sensor is provided to measure distance between the substrate face 134 of the first plate 130 and the substrate face 136 of the second plate 132. For example, one or more photoelectric sensors may be provided that measure distance between the substrate face 134 of the first plate 130 and the substrate face 136 of the second plate 132. In such examples, the photoelectric sensor(s) may be attached to the first plate 130 and/or the second plate 132. Also, one or more photoelectric sensors may be provided that measure how far the second plate 132 moves along the vertical axis V, from the default position as described herein. Where utilized, the photoelectric sensor(s) may be in communication with the HMI 126, or the controller thereof, such that the HMI 126 is operable to control operation of the first actuator 154 and/or the second actuator 184 as described above. In embodiments, various other sensors may be utilized to determine the distance between the substrate faces 134, 136, for example, a linear variable differential transformer device.

In embodiments, the apparatus 100 comprises an acoustic sensor 250. The acoustic sensor 250 may be attached at various locations of the apparatus 100, such as on either or both of the substrate faces 134, 136. However, the acoustic sensor 250 may be located at various other locations within the apparatus 100. Where utilized, the acoustic sensor 250 is communicatively coupled to the HMI 126, or the controller thereof, such that the HMI 126 is operable to detect failure (e.g., breakage or cracking) of the substrate during the two-point bend test. In some of these embodiments, the HMI 126 is operable to cease operation of the first actuator 154 and/or the second actuator 184 upon detection of the breakage of the substrate via the acoustic sensor 250. In some of these embodiments, upon detecting that the substrate has broken, the HMI 126 causes the second actuator 184 to move the second plate 132 back to its default position and the HMI 126 also causes the first actuator 154 to move the first plate 130 back to a default position at which it was located prior to starting the two-point bend test. Also, upon detection of the breakage, the HMI 126 is programmed to record the spacing between the first plate 130 and the second plate 132 at which the breakage occurred and/or record a location of the second plate 132 during its translation along the vertical axis V when the breakage occurred. This may be beneficial, for example, when the substrate is transparent as glass failure is detected by acoustic detection rather than high speed video.

In embodiments, the apparatus 100 comprises a load cell 252 operable to measure loading of the substrate and such that the load exerted on the substrate at the point of failure may be recorded. Where utilized, the load cell 252 is communicatively coupled to the HMI 126, or the controller thereof, such that the HMI 126 is operable measure, record, and/or output data indicative of loading of the substrate during the two-point bend test. In embodiments, the load cell 252 is positioned on the first plate 130 and/or on the second plate 132. In embodiments, the load cell 252 is positioned between the first plate 130 and the chassis 148, such that the load cell 252 is operable to detect force exerted on the first plate 130 via the substrate during testing. In embodiments, the load cell 252 is positioned between the second plate 132 and the first sliders 180 and the second sliders 182 thereof.

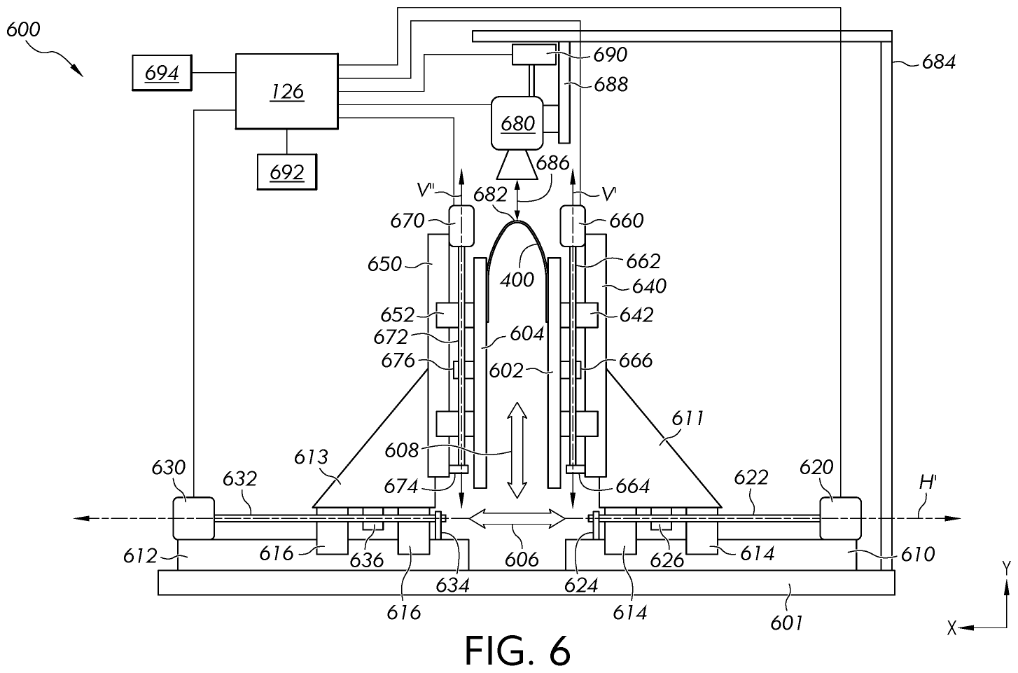

In embodiments, the apparatus 100 comprises a camera system 254 for recording the substrate during testing. Where utilized, the camera system 254 is communicatively coupled to the HMI 126, or the controller thereof, such that the HMI 126 is operable record and monitor loading of the substrate during the two-point bend test and capture images (and/or video) of the substrate at the moment it fractures. In embodiments, the camera system 254 is positioned within the testing cavity 106 of the apparatus 100 in a position oriented towards the apex of the bend formed in the substrate. In embodiments, the camera system 254 may be utilized to measure the spacing between the first plate 130 and the second plate 132, for example, at the moment when the substrate fractures. Also, based on the image(s) of the substrate of the substrate as it fractures, it is possible to determine where the fracture occurred in the substrate. An embodiment of the camera system 254 is discussed below, with reference to FIG. 6.

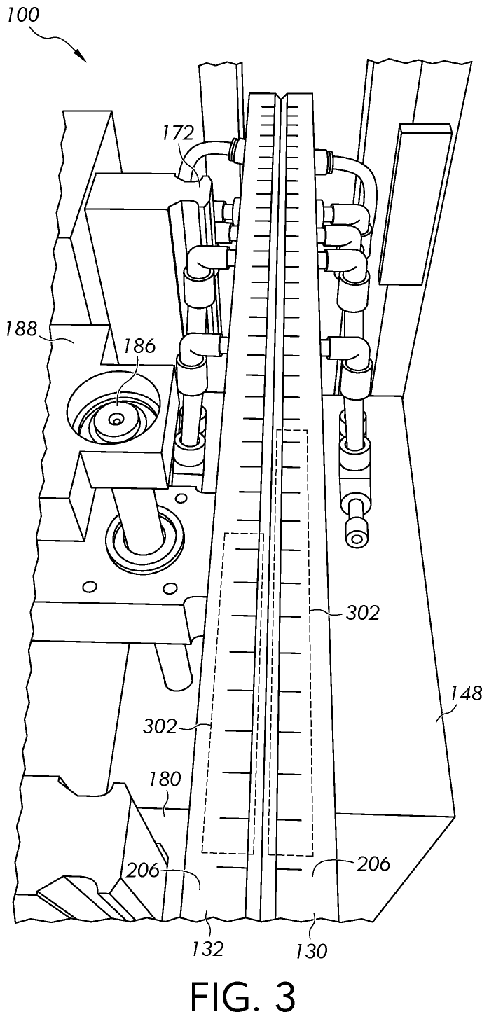

The first plate 130 and the second plate 132 each includes a first side 202, a second side 204, an upper side 206 extending between the first side 202 and the second side 204, and a lower side 208 also extending between the first side 202 and the second side 204 but opposite the upper side 206. When conducting a two-point bend test, a substrate is initially loaded into the apparatus 100 and attached to the first plate 130 and the second plate 132. When initially loading the substrate, the operator may slightly pre-bend the substrate (i.e., a low stress bend made by hand that is intended to initiate the correct bend direction of the substrate). When attaching the substrate, the substrate is aligned on the substrate face 134 and the substrate face 136 such that the bend formed in the substrate during the test approximates how the substrate will be bent in actual use. FIG. 3 illustrates close-up view of the upper sides 206 of the first plate 130 and the second plate 132 that are configured to facilitate alignment of the substrate on the substrate face 134 of the first plate 130 and on the substrate face 136 of the second plate 132, according to one or more embodiments of the present disclosure. In the illustrated embodiment, registration marks 302 are provided or formed on the upper sides 206 of the first plate 130 and the second plate 132. The registration marks 302 each comprise markings 304 that denote or correspond with a unit of measure, for example, as SI unit markings or Imperial unit markings. Here, the markings 304 extend along an entire length of the upper sides 206; however, they may extend along less than the entire length of the upper sides 206. Also, the registration marks 302 may be provided on other areas of the first plate 130 and/or the second plate 132 in addition to or in lieu of the upper side 206, for example, on the first side 202, the second side 204, and/or the lower side 208. Also or instead, the registration marks 302 may be provided on the substrate face 134 and the substrate face 136.

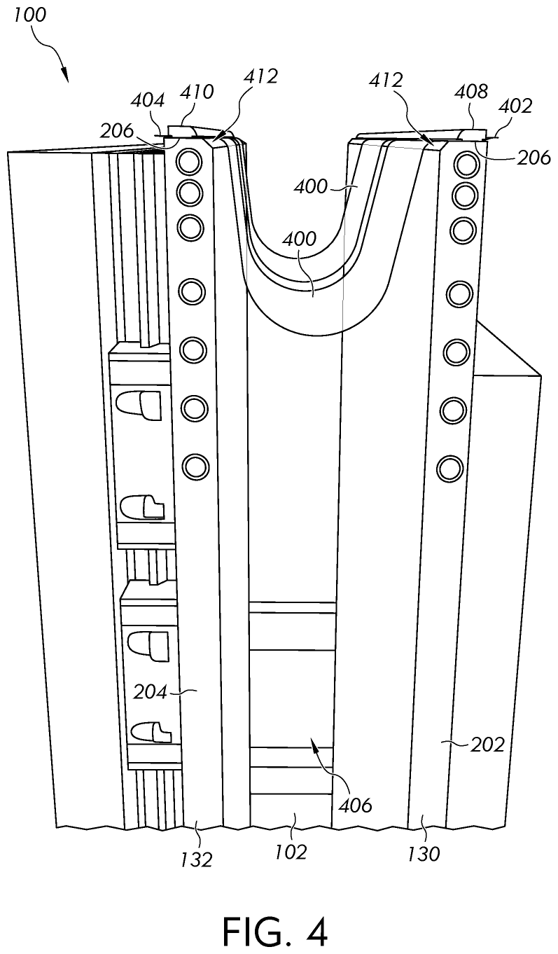

FIG. 4 illustrates a substrate 400 attached to the first plate 130 and the second plate 132, according to one or more embodiments of the present disclosure. The substrate 400 includes a first end 402 attachable to the first plate 130 and a second end 404 attachable to the second plate 132. When loading the substrate 400 in the apparatus 100, the substrate 400 is slightly bent, as shown in FIG. 4, and then placed between the first plate 130 and the second plate 132, with the first end 402 of the substrate 400 provided on the upper side 206 of the first plate 130 and with the second end 404 of the substrate 400 provided on the upper side 206 of the second plate 132. In some embodiments, the substrate 400 is loaded vertically into a space 406 defined between the first plate 130 and the second plate 130, wherein the substrate 400 would be slightly bent and positioned above the space 406 (and above the first plate 130 and the second plate 132), and then lowered down into the space 406 towards the base 102.

Loading the substrate 400 may also include securing the substrate 400 to the first plate 130 and to the second plate 132. To secure the first end 402 and the second end 404 of the substrate 400 to the first plate 130 and the second plate 132, respectively, a first clamp 408 and a second clamp 410 are utilized to retain the substrate 400. Here, the first clamp 408 and the second clamp 410 are magnets that are attracted to the material of the first plate 130 and the second plate 132, such that the first clamp 408 and the second clamp 410 will hold the first end 402 and the second end 404 of the substrate 400 on the upper side 206 associated therewith when provided thereon. For example, when the substrate 400 is positioned between the first plate 130 and the second plate 132, the first end 402 of the substrate 400 may extend over the upper side 206 of the first plate 130 and the second end 404 of the substrate 400 may extend over the upper side 206 of the second plate 132; and then the first clamp 408 may be placed on the upper side 206 of the first plate 130, on top of the first end 402 of the substrate 400, to thereby retain the first end 402 of the substrate 400 between the first clamp 408 and the first plate 130, and then the second clamp 410 may be placed on the upper side 206 of the second plate 132, on top of the second end 404 of the substrate 400, to thereby retain the second end 404 of the substrate 400 between the second clamp 410 and the second plate 132. In the illustrated embodiment, a chamfer 412 is provided or formed on the first plate 130 and on the second plate 132, at the transition or edge between the upper side 206 and the substrate face 134 of the first plate 130 and at the transition or edge between the upper side 206 and the substrate face 136 of the second plate 132.

In embodiments, the apparatus 100 may be configured to apply vacuum pressure or suction at the substrate face 134 of the first plate 130 and/or the substrate face 136 of the second plate 132, and such vacuum pressure or suction will help to retain or hold the substrate 400 on the substrate face 134 and/or the substrate face 136. Referring back to FIG. 1B, the apparatus 100 includes a vacuum pump 220 that generates negative pressure by compressed air. The vacuum pump 220 may be connected to the first plate 130 and/or the second plate 132 via one or more hoses or tubes (not shown). As further described herein, the first plate 130 and/or the second plate 132 may be configured to apply vacuum pressure, for example, at the substrate face 134 and/or the substrate face 136, that will assist in retaining the substrate 400 to the substrate face 134 and/or the substrate face 136. In embodiments, the vacuum pump 220 applies vacuum pressure at both the first plate 130 and the second plate 132 such that the vacuum pressure exhibited at the substrate face 134 and the substrate face 136 is substantially equal. In other embodiments, the vacuum pump 220 is configured to separately control vacuum pressure applied at the substrate face 134 and the substrate face 136, such that the vacuum pressure exhibited at the substrate face 134 may be different than the vacuum pressure exhibited at the substrate face 136. For example, the vacuum pump 220 may comprise a first pump operably connected to the first plate 130 for applying vacuum pressure at the substrate face 134 thereof and the vacuum pump 220 may also comprise a second pump operably connected to the second plate 132 for applying vacuum pressure at the substrate face 136 thereof. The vacuum pump 220 is operable to apply different amounts of vacuum pressure at the substrate face 134 and the substrate face 136. Also, the vacuum pump 220 is communicatively coupled to the HMI 126, for example, to the controller thereof, such that operation of the vacuum pump 220 and the amount of vacuum pressure that it exerts at the first plate 130 and the second plate 132 may be controlled and set by a user or a pre-programmed routine.

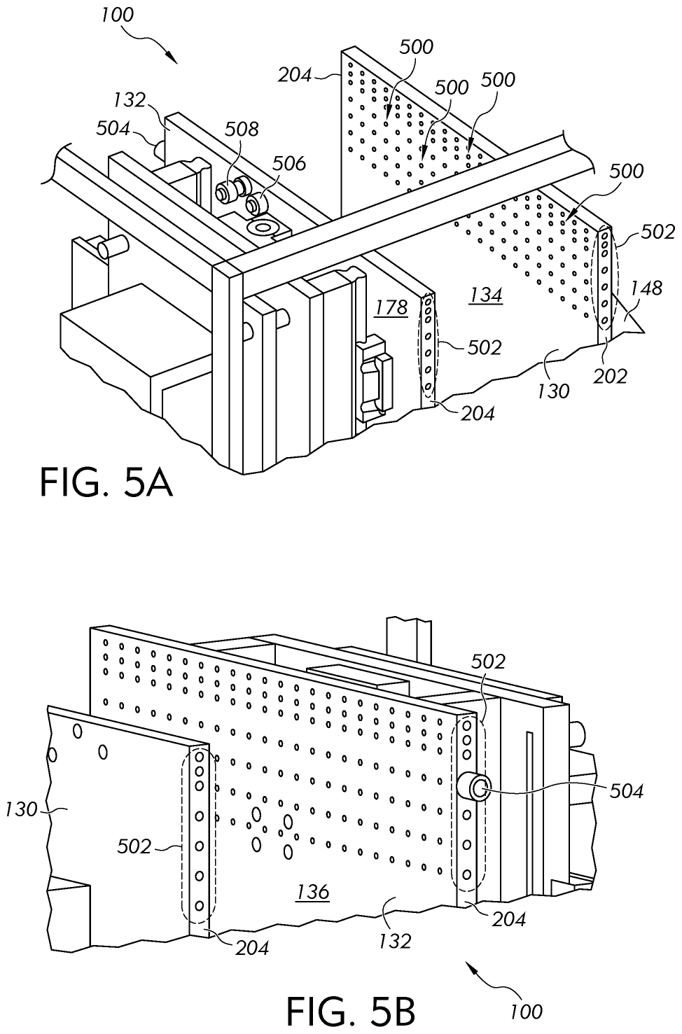

FIG. 5A and FIG. 5B depict the substrate face 134 of the first plate 130 and the substrate face 136 of the second plate 132, respectively, configured to apply vacuum pressure, according to one or more embodiments of the present disclosure. In the illustrated embodiment, a plurality of openings 500 are provided on each of the first plate 130 and the second plate 132. In particular, the plurality of openings 500 are formed on the substrate face 134 of the first plate 130 and the substrate face 136 of the second plate 132. The plurality of openings 500 in the first plate 130 are all in communication with each other, for example, via a network of conduits (obscured from view) formed within the first plate 130. Similarly, the plurality of openings 500 in the second plate 132 are also all in communication with each other, for example, via a network of conduits (obscured from view) formed within the second plate 132. Vacuum pressure may be supplied through the plurality of openings 500 to secure the substrate 400 to the first plate 130 and the second plate 132 and/or to help retain the substrate 400 to the first plate 130 and the second plate 132 during testing.

In embodiments, the plurality of openings 500 may be arranged in a series of rows, with each row extending between the first side 202 and the second side 204, and each of the plurality of openings 500 in a particular row being in communication with the openings of the plurality of openings 500 in that particular row. However, in addition to being organized in rows or in lieu thereof, the plurality of openings 500 may be differently grouped. In these embodiments, channels 502 are formed in each of the first plate 130 and the second plate 132, where each of the channels 502 extends there-through between the first side 202 and the second side 204, and where each of the channels 502 corresponds with one of the particular rows of the plurality of openings 500 and is in communication with the plurality of openings 500 in that particular row. Here, a first fitting 504 may be connected to any one or more of the channels 502 and a tube (not shown) may be provided, wherein the tube includes a first end that is connected to the first fitting 504 provided on one of the channels 502 and a second end that is connected to the vacuum pump 220, such that vacuum pressure may be applied at the plurality of openings 500 in that particular row upon activation of the vacuum pump 220. In embodiments, a particular one of the channels 502 corresponds to more than one particular row of the plurality of openings 500, such that that particular one of the channels 502 is in communication with more than one particular row of the plurality of openings 500, thereby allowing vacuum pressure to be applied at the plurality of openings 500 in those more than one rows upon activation of the vacuum pump 220. In the illustrated embodiment, a second fitting 506 and a third fitting 508 are also provided on the rear surface 178 of the second plate 132. Here, the second fitting 506 is in communication with a different grouping (e.g., row(s)) of the plurality of openings 500 than the first fitting 504, and the third fitting 508 is in communication with yet another different grouping (e.g., row(s)) of the plurality of openings 500 than the first fitting 504 and the second fitting 506. Similarly, a second tube (not shown) may be connected to the second fitting 506 and the vacuum pump 220, such that vacuum pressure may be applied at the plurality of openings 500 associated with the second fitting 506 upon activation of the vacuum pump 220, and a third tube (also not shown) may be connected to the third fitting 508 and the vacuum pump 220, such that vacuum pressure may be applied at the plurality of openings 500 associated with the third fitting 508 upon activation of the vacuum pump 220. While the first fitting 504, the second fitting 506, and the third fitting 508 are only illustrated as being provided on the second plate 132 but not on the first plate 130 in the illustrated embodiment, it will be appreciated that vacuum pressure may be applied to the first plate 130 in a similar manner as descried with reference to the second plate 132.

FIG. 6 illustrates an alternate testing apparatus 600, according to one or more embodiments described herein. As with the apparatus 100 described above, the testing apparatus 600 (hereinafter, the “apparatus 600”) generally includes a base 601, a first plate 602, and a second plate 604. The first plate 602 and the second plate 604 may be configured similar to the first plate 130 and the second plate 132, described above. However, in the illustrated embodiments, the first plate 602 and the second plate 604 are each movable in two degrees of freedom. Here, for example, the first plate 602 is movable relative to the second plate 604 along a horizontal axis H′, which is parallel to an X direction of the coordinate axes depicted in FIG. 6, and along a first vertical axis V′, which is parallel to a Y direction of the coordinate axes depicted in FIG. 6; whereas, the second plate 604 is also movable along the horizontal axis H′, relative to the first plate 602, and also movable along a second vertical axis V″, which is parallel to a Y direction of the coordinate axes depicted in FIG. 6. Thus, the first plate 602 and the second plate 604 are each movable horizontally, as indicated by arrow 606 and as described above with reference to the first plate 130 in FIGS. 1A and 1B, and the first plate 602 and the second plate 604 are also each movable vertically, as indicated by the arrow 608 and as described above with reference to the second plate 132 in FIGS. 1A and 1B.

As shown, the first plate 602 is slidably provided on a first rail 610 and the second plate 604 is slidably provided on a second rail 612. The first plate 602 is supported by a first chassis 611, and a first slider 614 is attached to the first chassis 611. The first slider 614 is slidably coupled to the first rail 610 such that the first chassis 611 and the first plate 602 may slide along the first rail 610 as indicated by the arrow 606. Similarly, the second plate 604 is supported by a second chassis 613, and a second slider 616 is attached to the second chassis 613. The second slider 616 is slidably coupled to the second rail 612 such that the second chassis 613 and the second plate 604 may slide along the second rail 612 as indicated by the arrow 606. In other embodiments, the first plate 602 and the second plate 604 are slidably provided on the same rail structure, for example, the first rail 610 the second rail 612 may be connected together as a unitary rail structure.

A first horizontal actuator 620 is attached relative to the base 601 for translating the first plate 602 as indicated by the arrow 606. The first horizontal actuator 620 rotates a first horizontal drive screw 622, and the first horizontal drive screw 622 extends from the first horizontal actuator 620 along the horizontal axis H′ and is rotatably supported by a first horizontal bearing 624. A first horizontal drive nut 626 is attached to the first plate 602 and includes a threaded bore (obscured from view). The first horizontal drive screw 622 extends through the threaded bore of the first horizontal drive nut 626, and a thread of the first horizontal drive screw 622 engages the threaded bore of the first horizontal drive nut 626 such that rotation of the first horizontal drive screw 622 correspondingly translates the first horizontal drive nut 626, which thereby translates the first plate 602 as indicated by the arrow 606. The first horizontal actuator 620 is communicably coupled to the HMI 126.

A second horizontal actuator 630 is attached relative to the base 601 for translating the second plate 604 as indicated by the arrow 606. The second horizontal actuator 630 rotates a second horizontal drive screw 632, and the second horizontal drive screw 632 extends from the second horizontal actuator 630 along the horizontal axis H′ and is rotatably supported by a second horizontal bearing 634. A second horizontal drive nut 636 is attached to the second plate 604 and includes a threaded bore (obscured from view). The second horizontal drive screw 632 extends through the threaded bore of the second horizontal drive nut 636, and a thread of the second horizontal drive screw 632 engages the threaded bore of the second horizontal drive nut 636 such that rotation of the second horizontal drive screw 632 correspondingly translates the second horizontal drive nut 636, which thereby translates the second plate 604 as indicated by the arrow 606. The second horizontal actuator 630 is communicably coupled to the HMI 126

The first plate 602 is also configured to translate, relative to the first chassis 611, along the first vertical axis V′. In the illustrated embodiment, a first vertical rail 640 is attached to the first chassis 611 and the first plate 602 is slidably provided on the first vertical rail 640. As depicted, a first vertical slider 642 is attached to the first plate 602, and the first vertical slider 642 is slidably coupled to the first vertical rail 640 such that the first vertical slider 642 and the first plate 602 may slide along the first vertical rail 640 as indicated by the arrow 608. Similarly, the second plate 604 is also configured to translate, relative to the second chassis 613, along the second vertical axis V″. In the illustrated embodiment, a second vertical rail 650 is attached to the second chassis 613 and the second plate 604 is slidably provided on the second vertical rail 650. As depicted, a second vertical slider 652 is attached to the second plate 604, and the second vertical slider 652 is slidably coupled to the second vertical rail 650 such that the second vertical slider 652 and the second plate 604 may slide along the second vertical rail 650 as indicated by the arrow 608.

A first vertical actuator 660 is attached relative to the base 601 for translating the first plate 602 as indicated by the arrow 608. The first vertical actuator 660 rotates a first vertical drive screw 662, and the first vertical drive screw 662 extends from the first vertical actuator 660 along the first vertical axis V′ and is rotatably supported by a first vertical bearing 664. A first vertical drive nut 666 is attached to the first plate 602 and includes a threaded bore (obscured from view). The first vertical drive screw 662 extends through the threaded bore of the first vertical drive nut 666, and a thread of the first vertical drive screw 662 engages the threaded bore of the first vertical drive nut 666 such that rotation of the first vertical drive screw 662 correspondingly translates the first vertical drive nut 666, which thereby translates the first plate 602 as indicated by the arrow 608. The first vertical actuator 660 is communicably coupled to the HMI 126.

A second vertical actuator 670 is attached relative to the base 601 for translating the second plate 604 as indicated by the arrow 608. The second vertical actuator 670 rotates a second vertical drive screw 672, and the second vertical drive screw 672 extends from the second vertical actuator 670 along the second vertical axis V″ and is rotatably supported by a second vertical bearing 674. A second vertical drive nut 676 is attached to the second plate 604 and includes a threaded bore (obscured from view). The second vertical drive screw 672 extends through the threaded bore of the second vertical drive nut 676, and a thread of the second vertical drive screw 672 engages the threaded bore of the second vertical drive nut 676 such that rotation of the second vertical drive screw 672 correspondingly translates the second vertical drive nut 676, which thereby translates the second plate 604 as indicated by the arrow 608. The second vertical actuator 670 is communicably coupled to the HMI 126.

In embodiments, the apparatus 600 may include a camera 680 that monitors the substrate 400 positioned between the first plate 602 and the second plate 604. In embodiments, the camera 680 is utilizable to determine the spacing between the first plate 602 and the second plate 604, such that the spacing between the first plate 602 and the second plate 604 at the moment when the substrate 400 fractures may be determined. The camera 680 is communicably coupled to the HMI 126. In the illustrated embodiment, the camera 680 is positioned above the substrate 400 such that it is able to capture video or images of an apex 682 formed in the substrate 400 when bent. In the illustrated embodiment, the camera 680 may be suspended above the substrate 400 via a frame structure 684. In this manner, the camera 680 may be positioned above the apex 682 of the substrate 400 when bent, with the camera 680 being spaced at a distance 686 from the apex 682 of the substrate 400. In embodiments, the camera 680 is a high speed camera. In these embodiments, one or more light sources (e.g., LED light sources) (not shown) may be utilized to illuminate the substrate 400 as it is filmed by the camera 680. The light sources may also be suspended from the frame structure 684 and positioned at various locations to illuminate the substrate 400 monitored by the camera 680.

In embodiments, the camera 680 may be movable relative to the frame structure 684, such that the distance 686 between the camera 680 and the apex 682 of the substrate 400 may be adjusted by moving the camera 680. In the illustrated embodiment, the camera 680 is slidably coupled to a track 688 that is suspended from the frame structure 684, and the camera 680 is movable along the track 688 as indicated by the arrow 608. In the illustrated embodiment, a camera actuator 690 is operable to move the camera 680 along the track 688 and thereby adjust the distance 686 between the camera 680 and the apex 682 of the substrate 400. In embodiments, the camera actuator 690 is communicatively connected to the HMI 126 such that operation of the camera actuator 690 is controllable. In other embodiments, the camera 680 is manually movable along the track 688 and, in these embodiments, a locking mechanism may be utilized to selectively secure the camera 680 at a desired location along the track 688.

The apparatus 600 may also include an acoustic sensor 692 operably connected to the HMI 126. During testing, the substrate 400 will eventually fracture, and the acoustic sensor 692 detects sound (or acoustic signals) emitted from the substrate 400 upon fracturing. The HMI 126 is operable determine the moment that the substrate 400 fractures based on acoustic data captured by the acoustic sensor 692. The acoustic sensor 692 may be located at various locations of the apparatus 600 where it is operable to detect fracture of the substrate 400. In embodiments, the acoustic sensor 692 is positioned on the first plate 602 and/or on the second plate 604.

During testing, the camera 680 records the substrate 400 as it is bent between the first plate 602 and the second plate 604, while the acoustic sensor 692 detects fracturing of the substrate 400 fractures, for example, at the apex 682. Thus, the camera 680 captures images of the substrate 400 during testing and, using data from the acoustic sensor 692, the HMI 126 is operable to generate an image of the substrate 400 at the precise moment at which the fracture occurred. Failure stress of the substrate 400 may then be calculated based on the location at which the fracture occurs in the substrate 400 relative to the apex 682, as failure stress is a function of the fracture position relative to the apex 682. Accordingly, embodiments described herein are operable to provide a precise determination of failure stress.

In embodiments, both the first plate 602 and the second plate 604 are movable in two-degrees of freedom (i.e., the first plate 602 and the second plate 604 each include a first stage and a second stage). In embodiments, the apparatus 600 is operable to maintain the distance 684 at which the apex 682 of the substrate 400 is spaced from the camera 680, such that the distance 684 remains constant during testing. During testing, the HMI 126 controls the first horizontal actuator 620 to translate the first plate 602 upward and/or downward (as indicated by the arrow 608) to thereby shift the apex 682 throughout the length of the substrate 400; however, such vertical translation of the first plate 602 will correspondingly move the apex 682 relative to the camera 680, such that the distance 684 between the apex 682 and the camera 680 will increase as the first plate 602 moves downward and decrease as the first plate 602 moves upward towards the camera 680. To maintain the apex 682 in the same location relative to the camera 680 and thus keep the distance 684 constant during testing, the HMI 126 is operable to control operation of the second horizontal actuator 630, such that the second plate 604 translates the same distance and at the same speed as the first plate 602, but in an opposite direction from the vertical motion of first plate 602. In another embodiment, the HMI 126 controls operation of the camera actuator 690 to thereby translate the camera 690 upward or downward with the first plate 602 to thereby keep the distance 684 constant during testing using feedback from the camera 680. Here, the HMI 126 is programmed to calculate the distance 684 between the apex 682 of the substrate 400, and the HMI 126 is operable to control actuation of the camera actuator 690 based on feedback indicative of the distance 686 received from the camera 680 to maintain the distance 684 at a constant value. In other embodiments, the HMI 126 is programmed to calculate the distance 684 and controls operation of the second vertical actuator 670 to keep the distance 684 constant based on feedback from the camera 680 indicative of the distance 686. In even other non-illustrated embodiments, the camera 690 is physically coupled to the first plate 602 such that the camera 680 moves in tandem with the first plate 602 to maintain the distance 684 at constant value during testing.

The apparatus 600 may include a load cell 694 to collect force data during test. In embodiments, the load cell 694 is an off-axis pancake load cell positioned on the first plate 602 and/or on the second plate 604. Where utilized, the load cell(s) 694 may be operably connected to the HMI 126, or the controller thereof, such that the HMI 126 is operable to detect and measure loading of the substrate 400 during the two-point bend test. The HMI 126 is operable to calculate forces applied to the substrate 400 and to record forces at which the substrate 400 breaks, if at all. Where utilized, the load cell 694 may be positioned on either or both of the first plate 602 and the second plate 604 such that the load cell(s) 694 is operable to detect loading of the first plate 602 and/or the second plate 604. In embodiments, the load cell 694 is positioned behind the first plate 602, in between the first plate 602 and the first vertical slider 642 thereof, and in other embodiments, the load cell 694 is also or instead positioned in between the second plate 604 and the second vertical slider 652 thereof.

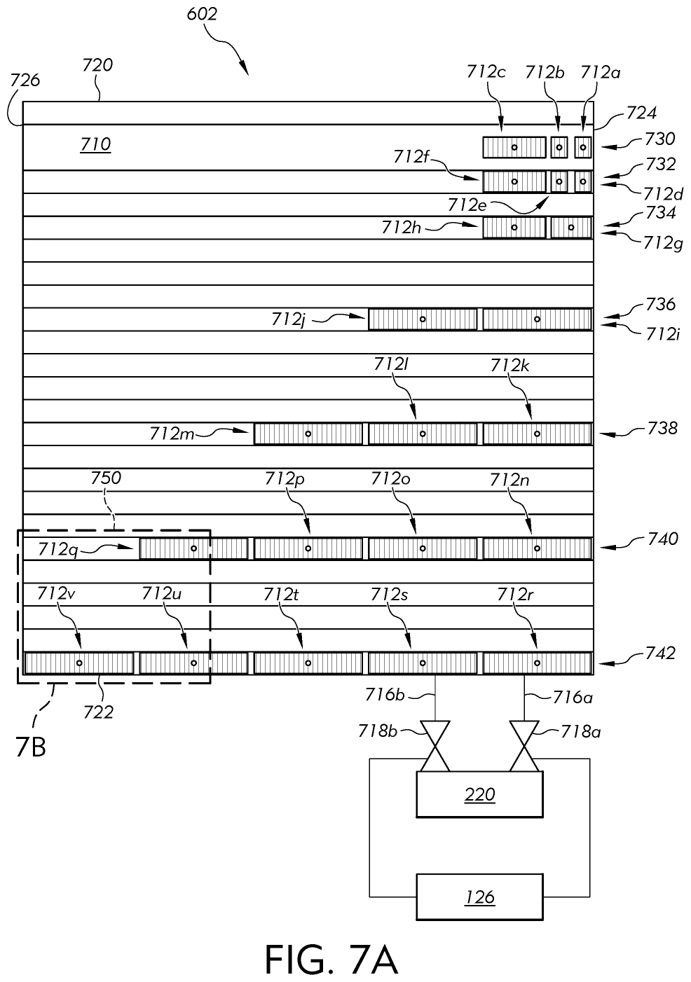

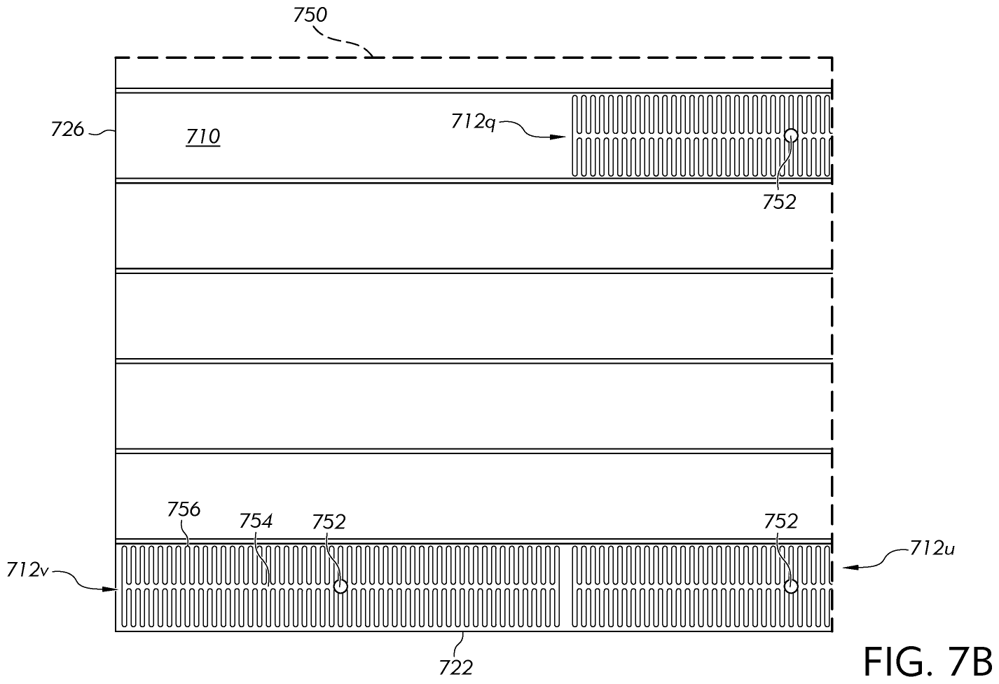

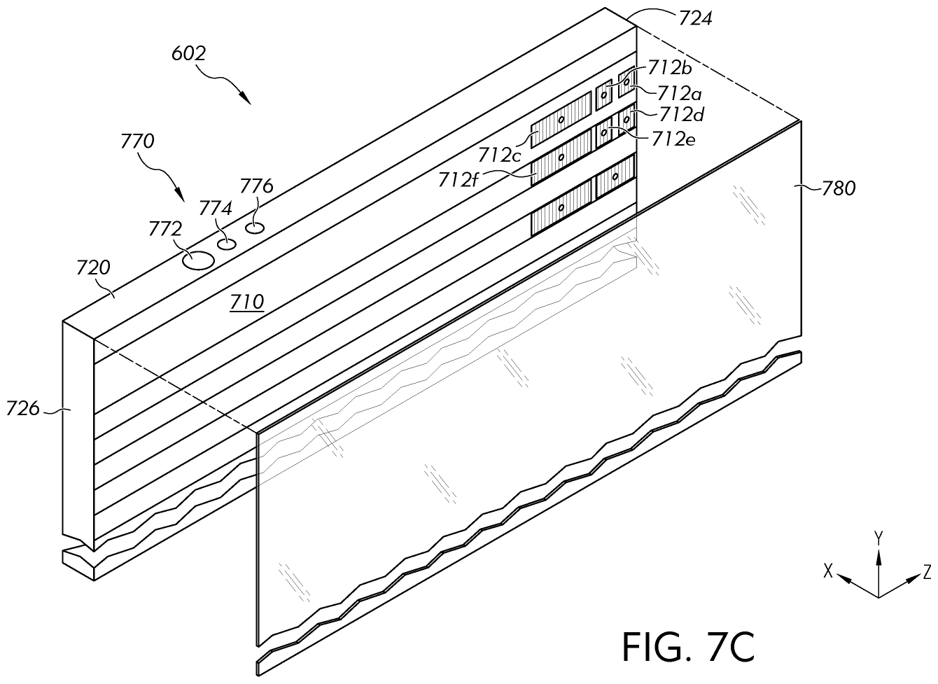

Referring to FIGS. 7A-7C, FIG. 7A schematically depicts a substrate face 710 of the first plate 602 having a plurality vacuum zones 712a-v, according to one or more embodiments shown and described herein. As described below, vacuum pressure is applied to each of the vacuum zones 712a-v via the vacuum pump 220 in order to secure the first end 402 of the substrate 400 to the first plate 602. Thus, each of the vacuum zones 712a-v is fluidly connected to the vacuum pump 220. While FIG. 7A illustrates just the substrate face 710 of the first plate 602, the second plate 604 may also include vacuum zones that correspond with the vacuum zones 712a-v of the first plate 602 to thereby secure the second end 404 of the substrate 400 to the second plate 604. Also, embodiments of the vacuum zones 712a-v described with reference to FIG. 7A may be integrated into the first plate 130 and the second plate 132 described above with respect to FIGS. 1A-2B.

In the illustrated embodiment, the plurality of vacuum zones 712a-v includes a first zone 712a, a second zone 712b, a third zone 712c, a fourth zone 712d, a fifth zone 712e, a sixth zone 712f, a seventh zone 712g, an eighth zone 712h, a ninth zone 712i, a tenth zone 712j, an eleventh zone 712k, a twelfth zone 712l, a thirteenth zone 712m, a fourteenth zone 712n, a fifteenth zone 7120, a sixteenth zone 712p, a seventeenth zone 712q, an eighteenth zone 712r, a nineteenth zone 712s, a twentieth zone 712t, a twenty-first zone 712u, and a twenty-second zone 712v. However, more or less of the vacuum zones 712a-v may be provided. While FIG. 7A illustrates an example where just the eighteenth zone 712r is fluidly connected to the vacuum pump 220 via a first conduit 716a and the nineteenth zone 712s is fluidly connected to the vacuum pump 220 via a second conduit 716b, each of the vacuum zones 712a-v depicted in FIG. 7A may be individually connected to the vacuum pump 220 via a separate conduit. In these embodiments, a valve or solenoid switch is associated with each of the vacuum zones 712a-v such that each of the vacuum zones 712a-v may be selectively activated or deactivated by control of the valve or solenoid switch. In this manner, vacuum pressure may be selectively applied only at desired vacuum zones 712a-v, for example, upon which the first end 402 of the substrate 400 is positioned. While FIG. 6 depicts an embodiment where a first solenoid switch 718a is in communication with the first conduit 716a of the eighteenth zone 712r and a second solenoid switch 718b is in communication with the second conduit 716b of the nineteenth zone 712s, an individual solenoid switch may be associated with each of the vacuum zones 712a-v to independently control activation of vacuum pressure at each of the vacuum zones 712a-v. In the illustrated embodiment, the first solenoid switch 718a and the second solenoid switch 718b are separately controllable, such that the eighteenth zone 712r and the nineteenth zone 712s may be separately activated or deactivated. Also, the first solenoid switch 718a and the second solenoid switch 718b may each be connected to the HMI 126 such that they are controlled via the HMI 126.

In embodiments, the vacuum zones 712a-v are utilized to retain the first end 402 of the substrate 400 to the substrate face 710 of the first plate 602. Accordingly, the vacuum zones 712a-v are positioned at locations where it is desirable to secure the substrate 400 to the substrate face 710 of the first plate 602. Further, the vacuum zones 712a-v are positioned to help align the substrate 400. In the illustrated embodiment, the first plate 602 includes an upper edge 720 and a lower edge 722, as well as a first edge 724 and a second edge 726 extending between the upper edge 720 and the lower edge 722. Here, the vacuum zones 712a-v are arranged in rows between the upper edge 720 and the lower edge 722, wherein the rows border the first edge 724 and extend towards the second edge 726. In particular, the first zone 712a, the second zone 712b, and the third zone 712c are in a first row 730 positioned proximate to the upper edge 720 and the first edge 724. The fourth zone 712d, the fifth zone 712e, and the sixth zone 712f are in a second row 732 positioned beneath the first row 730 that extends from the first edge 724 towards the second edge 726. The seventh zone 712g and the eighth zone 712h are in a third row 734 positioned beneath the second row 732. The ninth zone 712i and the tenth zone 712j are in a fourth row 736 positioned beneath the third row 734. The eleventh zone 712k, the twelfth zone 712l, and the thirteenth zone 712m are in a fifth row 738 positioned beneath the fourth row 736. The fourteenth zone 712n, the fifteenth zone 7120, the sixteenth zone 712p, and the seventeenth zone 712q are in a sixth row 740 positioned beneath the fifth row 738. The eighteenth zone 712r, the nineteenth zone 712s, the twentieth zone 712t, the twenty-first zone 712u, and the twenty-second zone 712v are in a seventh row 742 positioned beneath the sixth row 740 and proximate to the lower edge 722 of the first plate 602.

Also, the vacuum zones 712a-v have various sizes and may be sized to correspond to pre-determined sizes of the substrate 400 to be tested. For example, if a substrate 400 has a width of 100 mm, at least some of the vacuum zones 712a-v may be 100 mm in width (e.g., the vacuum zones 712i-v), or two or more neighboring vacuum zones 712a-v together may be 100 mm in width (e.g., the vacuum zones 712a-c, the vacuum zones 712d-f, and the vacuum zones 712g-h). In the illustrated example, the vacuum zones 712a-v do not all have the same width, but instead have different widths so as to accommodate substrates 400 having different widths. For example, for short and narrow substrates, the first end 402 of the substrate 400 may cover and align with the first zone 712a, which is activated to retain the first end 402 of the substrate 400, and the remaining vacuum zones 712b-v may be deactivated; if the substrate 400 is slightly wider but has the same overall length, the first end 402 thereof may also cover and align with the second zone 712b (or both the second zone 712b and the third zone 712c), in which case the second zone 712b (or both the second zone 712b and the third zone 712c) would be activated in addition to the first zone 712a, and the remaining vacuum zones 712c-v (or the remaining vacuum zones 712d-v) may be deactivated. If the substrate 400 was slightly longer, one or more of the vacuum zones 712d-f in the second row 732 may be activated instead, wherein the number of vacuum zones 712d-f activated in the second row 732 depends on the width of the substrate 400. For example, for narrows substrates, just the fourth zone 712d may be activated (or just the fourth zone 712d and the first zone 712a may be activated), whereas for wider substrates, just the fourth zone 712d and the fifth zone 712e may be activated (and the first zone 712a and the second zone 712b may also be activated); and for even wider substrates, the fourth zone 712d, the fifth zone 712e, and the sixth zone 712f may be activated (and the first zone 712a, the second zone 712b, and the third zone 712c may also be activated). Thus, for extremely long substrates, the first end 402 of the substrate 400 will be aligned with and covering one or more of the vacuum zones 712r-v in the seventh row 742; and, for long substrates that are narrow, just the eighteenth zone 712r would be activated, but one or more of the other vacuum zones 712s-v in the seventh row 742 would be activated if the substrate 400 was wider, to ensure that vacuum pressure is applied along the width of the first end 402 of the substrate 400. Also, as described above, the vacuum zones 712a-v in more than one row may be activated to ensure that the substrate 400 doesn't buckle during testing and is retained on the first plate 602. For example, where the first end 402 of the substrate 400 is positioned over the eighteenth zone 712r, the nineteenth zone 712s, and the twentieth zone 712t in the seventh row 742, one or more vacuum zones 712 in the sixth row 740 (and/or the fifth row 738, the fourth row 736, the third row 734, the second row 732, the first row 730) may be activated to help adhere the substrate 400 to the substrate face 710 of the first plate 602.

FIG. 7B depicts a detailed view of a region 750 of the first plate 602 identified in FIG. 7A. In particular, FIG. 7B illustrates the seventeenth zone 712q, the twenty-first zone 712u, and the twenty-second zone 712v, according to one or more embodiments shown and described herein. It will be appreciated that, while not depicted in FIG. 7B, the other vacuum zones 712a-p, 712r-t may be similarly constructed as described herein. Each of the vacuum zones 712a-v includes at least one opening through which vacuum pressure is applied and, in the illustrated embodiment, each of the vacuum zones 712a-v includes an aperture 752 in the substrate face 710 through which vacuum pressure is applied. The aperture 752 extends through the first plate 602 and is coupled to the vacuum source 220 via a conduit, for example, as described with reference to the first conduit 716a and the second conduit 716b. Each of the vacuum zones 712a-v also includes a central channel 754 formed in the substrate face 710 of the first plate 602. The central channel 754 is machined into the substrate face 710 and extends from the aperture 752 towards the second edge 726 and the first edge 724. Further, each of the vacuum zones 712a-v includes a plurality of grooves 756 extending from the central channel 754. The plurality of grooves 756 are machined into the substrate face 710 and extend from the central channel 754 towards the upper edge 720 and the lower edge 722. When the first end 402 of the substrate 400 covers the plurality of grooves 756 and the central channel 754, vacuum pressure supplied through the aperture 752 will adhere the first end 402 to the first plate 602.

The length of the central channel 754, as measured between the first edge 724 and the second edge 726 and along an axis parallel with the Z direction of the depicted coordinate axes, may vary amongst the vacuum zones 712a-v. The central channel 754 of some of the vacuum zones 712 is longer than the central channel 754 of other vacuum zones 712 and, the vacuum zones 712 having longer central channels 754 include more grooves 756. For example, referring again to FIG. 7A, the central channel 754 of the first zone 712a, the second zone 712b, the fourth zone 712d, and the fifth zone 712e is equal and relatively shorter than the central channel 754 of the other vacuum zones 712c, 712f, 712g-v, such the number of grooves 756 in each of the first zone 712a, the second zone 712b, the fourth zone 712d, and the fifth zone 712e is less than the number of grooves 756 in the other vacuum zones 712c, 712f, 712g-v. In this example, the seventh zone 712g is sized to be as wide as the first zone 712a and the second zone 712b (and as wide as the fourth zone 712d and the fifth zone 712e), such that the central channel 754 of seventh zone 712g is longer than that of the first zone 712a, the second zone 712b, the fourth zone 712d, and the fifth zone 712e, but shorter than that of the other vacuum zones 712c, 712f, 712h-v. In this manner, the seventh zone 712g has a greater number of grooves 756 than the first zone 712a, the second zone 712b, the fourth zone 712d, and the fifth zone 712e, but a lesser number of grooves 756 than the other vacuum zones 712c, 712f, 712h-v. Also, the third zone 712c, the sixth zone 712f, and the eighth zone 712h have an equally sized central channel 754 that is longer than the central channel 754 of the first zone 712a, the second zone 712b, the fourth zone 712d, the fifth zone 712e, and the seventh zone 712g, such that the third zone 712c, the sixth zone 712f, and the eighth zone 712h each include a greater number of grooves 756 than the first zone 712a, the second zone 712b, the fourth zone 712d, the fifth zone 712e, and the seventh zone 712g. However, the length of the central channel 754 in any one or more of the vacuum zones 712a-v may be longer or shorter than as depicted and have more or less grooves 756 extending therefrom therewith than as depicted.

FIG. 7C schematically depicts an upper portion of the first plate 602, according to one or more embodiments shown and described herein. In the illustrated embodiment, the first plate 602 includes scale features 770. Here, the scale features 770 are disposed on the upper edge 720; however, the any one or more of the scale features 770 may be disposed on a different portion of the first plate 602. Also, one or more of the scale features 770 may also or instead be disposed on the second plate 604.

As mentioned, the camera 680 may be a high speed camera and, during the test, the camera 680 captures an image of the substrate 400, as well as the first plate 602 and the second plate 604 between which the substrate 400 is retained, at the moment a fracture is formed in the substrate 400. The scale features 770 have a known dimension (e.g., a known diameter) and are also captured in this image, such that the spacing between the first plate 602 and the second plate 604 may be ascertained using the scale features 770 as reference. Thus, the scale features 770 allow the operator to verify that the testing apparatus 600 is properly calibrated, validate results of the software utilized to calculate spacing between the first plate 602 and the second plate 604, and/or determine whether there is an error in the software utilized to calculate spacing between the first plate 602 and the second plate 604. Further, the scale features 770 allow the operator to confirm and validate accuracy when viewing images and data at a later time after conclusion of the testing.

In the illustrated embodiment, the scale features 770 include a first scale feature 772 having a first diameter, a second scale feature 774 having a second diameter that is smaller than the first diameter, and a third scale feature 776 having a third diameter that is smaller than the second diameter. In the illustrated embodiment, the scale features 770 are apertures that are each formed by drilling a hole in the first plate 602. In embodiments, an element of known, predetermined size is provided in each of the holes. For example, a first element having a diameter corresponding to the first diameter may be positioned within the first scale feature 772, a second element having a diameter corresponding to the second diameter may be positioned within the second scale feature 774, and a third element having a diameter corresponding to the third diameter may be positioned within the third scale feature 776.

FIG. 7C also illustrates a sacrificial film 780 that may be provided on the first plate 602, according to one or more embodiments shown and described herein. While the sacrificial film 780 is only illustrated with respect to the first plate 602, the sacrificial film 780 may also be provided on the second plate 604 as described herein. As shown, the sacrificial film 780 may be disposed on the substrate face 710 of the first plate 602. The sacrificial film 780 may be sized to fully cover the substrate face 710 of the first plate 602 or to only cover a portion of the substrate face 710 that contacts the substrate 400. In the illustrated embodiment, the sacrificial film 780 fully covers the substrate face 710. During testing, glass shards may become embedded in the sacrificial film 780, such that the sacrificial film 780 may be a single use component that is easily installed before testing and easily removed after testing. The sacrificial film 780 includes an interior surface (obscured from view) that contacts the substrate face 710 of the first plate 602 and, in embodiments, the interior surface of the sacrificial film 780 includes an adhesive that retains the sacrificial film 780 to the first plate 602 but which may be easily peeled off from the first plate 602 after testing. In other embodiments, the sacrificial film 780 clings to the first plate 602 via an electrostatic charge, such as a cling wrap. By covering the substrate face 710 of the first plate 692 during testing, the sacrificial film 780 protects the first plate 692 from damage that may be caused by fracturing of the substrate 400 and, moreover, the sacrificial film 780 ensures that the testing apparatus 600 does not interact with the substrate 400 (e.g., during vertical translation of the first plate 602 and/or the second plate 604) and thereby impact strength distributions within the substrate 400.

In embodiments, the sacrificial film 780 is made of a porous or perforated polymeric material, such that the vacuum pressure applied at the substrate face 710 of the first plate 602 may be applied to the substrate 400 through the sacrificial film 780. The sacrificial film 780 may be made of various other materials, however, such as materials that would not damage the substrate 400, including but not limited to a paper material. In other embodiments, the sacrificial film 780 has cutouts that correspond with the vacuum zones 712a-v on the substrate face 710 of the first plate 602. For example, the sacrificial film 780 may have a plurality of cutouts corresponding with the central channel 754 and the grooves 756 of each of the vacuum zones 712a-v over which the sacrificial film 780 will be placed, such that vacuum pressure may be applied to the substrate 400 through the sacrificial film 780.

Embodiments described herein are also directed towards methods of testing a substrate pursuant to the two-point bend test methodology.

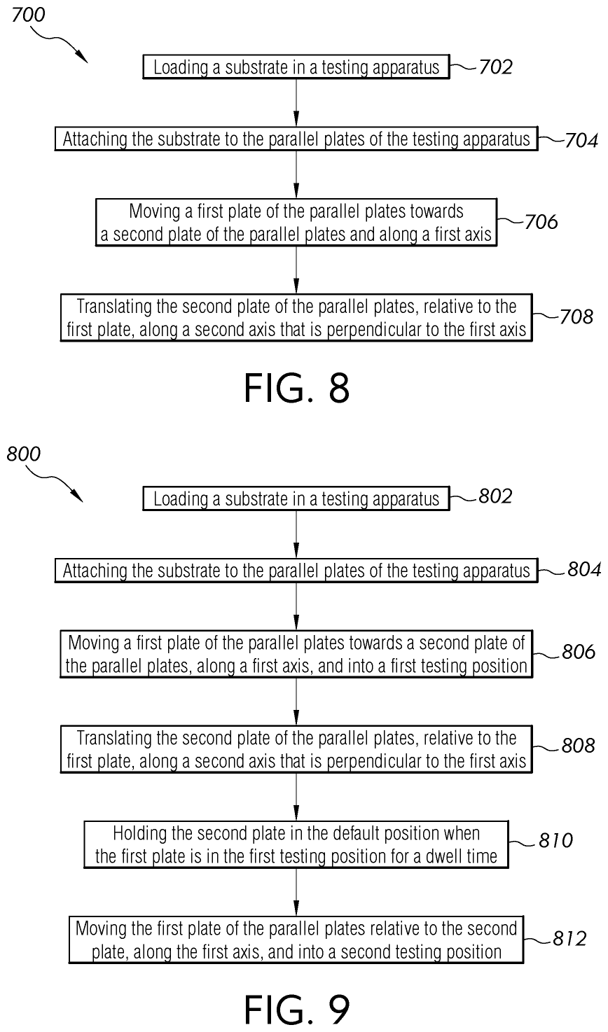

FIG. 8 illustrates a method 700 of testing a substrate, according to one or more embodiments of the present disclosure. In the illustrated embodiment, the method 700 includes, at 702, loading a substrate in a testing apparatus. The testing apparatus may comprise either the apparatus 100 or the apparatus 600, described above. Also, loading the substrate may further comprising pre-bending the substrate by hand, such that a pre-bend is formed in the substrate to thereby pre-load the substrate, wherein the pre-bend is a low stress bend that is intended to initiate the correct bend direction in the substrate. By pre-pending the substrate in this manner, the substrate is being pre-loaded with an initial amount of stress.

At 704, the method 700 includes attaching the substrate to parallel plates of the testing apparatus. The parallel plates may comprise the first plate 130 and the second plate 132, described above, or the first plate 602 and the second plate 604, described above. Also, attaching the substrate to parallel plates may further comprise attaching a first end of the substrate to a first plate of the parallel plates and attaching a second end of the substrate to a second plate of the parallel plates. In embodiments, the first end and the second end of the substrate are respectively attached to the first plate and the second plate via a magnetic clamp, such as the first clamp 408 and the second clamp 410 described above with reference to FIG. 4. In other embodiments, the first end and the second end of the substrate are respectively attached to the first plate and the second plate via vacuum pressure supplied as described above with reference to FIGS. 5A-5B and FIGS. 7A-7B.

In embodiments, the method 700 may further comprising aligning the substrate on the first plate and the second plate. For example, the first end of the substrate may be aligned with a first set of registration marks on the first plate and the second end of the substrate may be aligned with a second set of registration marks on the second plate, as described above with reference to FIG. 3. In embodiments, the substrate may be aligned on the first plate and the vacuum plate using vacuum zones, as described above in FIGS. 7A-7B.

At 706, the method 700 includes moving the first plate of the parallel plates towards the second plate of the parallel plates and along a first axis. In embodiments, the first plate is moved horizontally towards and relative to the second plate, for example, along the horizontal axis H referenced above in FIGS. 1A and 1B. In other embodiments, the second plate is moved horizontally towards and relative to the first plate. In even other embodiments, both the first plate and the second plate are movable along the horizontal axis H, such that they may both be moved together simultaneously. In such embodiments, a first actuator would be provided for moving the first plate towards the second plate and another actuator would be provided for moving the second plate towards the first plate simultaneously as the first actuator moves the first plate. In embodiments where the first plate and the second plate are both movable along the horizontal axis H, the first plate and the second plate may both be movable by a separate actuator as described with reference to the first plate 130 in FIGS. 1A and 1B and as described with reference to the first plate 602 and the second plate 604 in FIG. 6.

Different testing protocols may performed at 706. In some embodiments, the first plate moves, from a default position, towards and away from the second plate at a prescribed velocity. As mentioned above, the substrate is pre-bent when loaded in the testing apparatus such that the substrate is the pre-loaded when the first plate is in the default position and, with this protocol, the first plate may be moved, from the default position, into a testing position where it is spaced from the second plate by the desired spacing to thereby subject the substrate to a testing load. In embodiments, the first plate is moved from the default position, into the testing position, and then back into the default position, such that the substrate is subjected to a single cycle of two-point bend testing and fatigue testing. However, such movement of the first plate may be repeated for any number of cycles, as may be desired.

At 708, the method 700 includes translating the second plate of the parallel plates, relative to the first plate, along a second axis that is perpendicular to the first axis. In embodiments, the second plate is vertically translated, relative to the first plate, for example, along the vertical axis V referenced above in FIGS. 1A and 1B. In embodiments, the second plate is vertically translatable via a second actuator, for example, as described above with reference to the second plate 132 in FIGS. 1A and 1B. In other embodiments, both the first plate and the second plate are vertically translatable relative to each, for example, in order to maintain spacing between the apex of the substrate and the camera, as described above with reference to FIG. 6. In such latter embodiments, the first plate vertically translated in an opposite direction of the first plate for an equal distance and at an equal speed as the second plate, so as to maintain the apex of the substrate at a fixed position in space, for example, relative to a camera.

Different testing protocols may performed at 708. In embodiments, after the first plate has been moved into the testing position, the second plate vertically translates the prescribed distance at a prescribed velocity, from its default position, upward along the second axis into the upper test position, and then vertically translates back into the default position and continues vertically translating the prescribed distance at the prescribed velocity along the second axis into the lower test position, and then vertically translates the prescribed distance at the prescribed velocity upward along the second axis back into the default position. Such vertical translation of the second plate, from the default position to the upper test position, then from the upper test position to the lower test position, and then from the lower test position back to the default position constitutes a single cycle of translation bend testing, and any number of cycles of translation bend testing may be performed, as may be desired. Thus, the second plate may vertically translate up and down, relative to the first plate after the first plate has been moved into the testing position, so as to maximize the area or region of the substrate that is subject to two-point bend testing for a given platen spacing (i.e., the desired spacing between the first plate and the second plate). In some embodiments, such vertical translation may continue repeating until the substrate fails (i.e., the substrate cracks as determined via a sensor). In embodiments where the first plate is also vertically translatable, the first plate will vertically translate as the second plate vertically translates but, as mentioned above, the first plate will move in an opposite direction for an equal distance and at an equal speed as the second plate.

FIG. 9 illustrates another method 800 of testing a substrate, according to one or more embodiments of the present disclosure. In the illustrated embodiment, the method 800 includes, at 802, loading a substrate in a testing apparatus. This may be performed similar as described with reference to 702 in FIG. 8. The method 800 also includes, at 804, attaching the substrate to parallel plates of the testing apparatus. This too may be performed similar as described with reference to 704 in FIG. 8.

Then, at 806, the method 800 includes moving the first plate of the parallel plates towards the second plate of the parallel plates, along a first axis, and into a first testing position. This may be performed similar as described with reference to 706 in FIG. 8. The first testing position is a first prescribed desired spacing between the first plate and a second plate, wherein the substrate is subjected to a first test load.

Then, at 808, the method 800 includes translating the second plate of the parallel plates, relative to the first plate, along a second axis that is perpendicular to the first axis. This may be performed similar as described with reference to 708 in FIG. 8.

After vertically translating the second plate for a prescribed number of cycles (e.g., 1 cycle, 10 cycles, etc.), the method 800 may include, at 810, holding the second plate in the default position when the first plate is in the first testing position for a dwell time. The dwell time may be prescribed in the test protocol. This step may be optional and, therefore, the dwell time may be zero in some embodiments.

Then, at 812, the method 800 includes moving the first plate of the parallel plates relative to the second plate, along the first axis, and into a second testing position. The second testing position is a second prescribed desired spacing between the first plate and a second plate, wherein the substrate is subjected to a second test load. In embodiments, the second test position involves the second plate being positioned in closer proximity to the first plate than the first test position, such that the second test load would be greater than the first test load. However, in other embodiments, the second test position may involve the second plate being further from the first plate than when in the second test position, such that the second test load would be lesser than the first test load.

Once the first plate has been moved into the second testing position, the second plate may be vertically translated as described at 808. During this second instance of vertically translating the second plate, the second plate may be moved the same prescribed distance and/or at the same prescribed velocity as before, or the second plate may be moved a different prescribed distance and/or at a different prescribed velocity than as before. After this step, the test may be concluded, or continue repeating for as many cycles as may be desired, or continue repeating until failure of the substrate (i.e., the substrate cracks as determined via a sensor).

Referring again to FIG. 1A, the HMI 126 may allow the operator to input various test parameters. For example, the display 128 may be a touch screen display operable to allow input of testing parameters. Also or instead, the operator may input testing parameters via the plurality of user inputs 129. Without limitation, the testing parameters may include the desired spacing between the substrate face 134 of the first plate 130 and the substrate face 136 of the second plate 132, the prescribed velocity at which the first plate 130 moves towards the second plate 132 (and/or at which the second plate 132 moves towards the first plate 130) along the horizontal axis H, the amount of testing load to be exerted on the substrate when in the testing position (i.e., the first plate 130 and the second plate 132 are spaced at the desired spacing), the number of cycles of such movement along the horizontal axis H, the prescribed distance that the second plate 132 travels along the vertical axis V from the default position into the upper test position and/or the lower test position, the prescribed velocity at which the second plate 132 moves relative to the first plate 130 along the vertical axis V (and/or at which the first plate 130 moves in a similar manner), the number of cycles of such movement along the vertical axis V, the number of steps of the first plate 130 (i.e., where the first plate 130 is moved closer or further from the second plate 132 after translating the second plate 132 for the prescribed number of cycles) and parameters associated with testing at such subsequent steps, etc. In embodiment, at least one of the plurality of user inputs 129 comprises an emergency stop feature that the operator may activate to thereby immediately cease all testing of the substrate within the apparatus, such that the first plate 130 and the second plate 132 are each returned to their default positions.

As mentioned above, two-point bend testing involves bending the substrate such that a bend is formed in the substrate, wherein the bend in the substrate is defined by a radius and the bend is created by moving the first plate and/or the second plate towards each other. The radius of the bend at which the substrate is to be tested, however, is selected based on the particular intended end use of the substrate. For example, a first substrate or set of substrates may be proof tested when bent at a first radius, but a second substrate or set of substrates may be proof tested when bent with a different radius. Thus, the radius at which a particular substrate is to be bent may vary. Also, the amount of stress experienced at portions of the substrate that are bent at the radius during proof testing is a parameter that may be selected by the operator. For example, it may be selected to be less than the fatigue limit of the material at a particular radius into which the substrate is bent, such that it can be assured that the substrate will not fracture when bent at the radius during end use.

Disclosed herein are methods of determining a radius at which the substrate is to be bent and correlating that radius to a desired spacing between the first plate and the second plate that will bend the substrate at the radius. Such radius and desired spacing correlated therewith may be utilized to optimize efficiency of proof testing the substrate. In embodiments, the desired spacing and the radius resulting therefrom are calculated as a function of various factors, such as thickness of the substrate, compressive stress, material properties of the substrate, and intended end use of the substrate.

The following relationship may be utilized determine a desired spacing between the first plate and the second plate at which to proof test the substrate. As described below, the relationship between a proof stress (σ_{Bend}^{PPproof}) of the substrate, which is the stress at which the substrate should experience during proof test, and a use stress (σ_{Bend}^{PPuse}) of the substrate, which is the stress that the substrate is designed and/or intended to experience during end use by an end user, may be utilized to calculate the desired spacing between the first plate and the second plate. In particular, the desired spacing may be calculated with the following relationship, which is referred to as the “Stress Relationship.”

$${σ}_{B e n d}^{PPproof} = \frac{{σ}_{Bend}^{PPuse} - {σ}_{10 X}}{θ} + {σ}_{10 X}$$

In the Stress Relationship, the variable σ_{10X} is approximately equal to the surface compressive stress (CS) of the substrate (i.e., σ_{10X}≈CS). The surface compressive stress (CS) of the substrate is a design parameter and, therefore, a known parameter. Also in the Stress Relationship, the variable θ is the ratio of the fatigue limit for the substrate (K₀) to the fracture toughness of the glass (K_{1C}), such that

$$θ = \frac{{K}_{0}}{{K}_{1 C}} .$$

The fatigue limit for the substrate (K₀) is measured experimentally, but typically falls in the range of 20-40% of the fracture toughness of the glass (K_{1C}) for most substrates, such that the variable θ≈0.20 to 0.40. Thus, the variable θ is determined experimentally for the particular substrate of interest that will be subjected to proof testing.

Also in the Stress Relationship, the use stress σ_{Bend}^{PPuse} is a variable that may be calculated based on the intended use of the substrate. In particular, the use stress σ_{Bend}^{PPuse} refers to the bend stress that will be exhibited in the substrate when it is bent at the max radius intended during end use, and this variable may be calculated by ascertaining the spacing between the first plate and the second plate that creates the bend of the max radius. For example, in the case of a substrate utilized in foldable phone, the first and second plates may simulate opposite ends of the foldable phone that are bendable relative to each other to thereby create the bend in the substrate. The use stress σ_{Bend}^{PPuse} may be calculated with the following equation, which is referred to as the “Use Stress Equation.”

$${σ}_{Bend}^{PPuse} = \frac{1.198 E}{1 - {v}^{2}} ( \frac{h}{{D}^{′} - h} )$$

In the Use Stress Equation, the variable h is the thickness of the substrate. The thickness h of the substrate is a design choice and thus known. Also in the Use Stress Equation, the variable D′ is the parallel plate spacing between the first plate and the second plate that bends the substrate at a radius equal to the max radius that the substrate is intended to be bent during end use. The max radius that the substrate is intended to be bent during end use is a design choice, which may be correlated to the parallel plate spacing D′ that simulates the max radius. Thus, the parallel plate spacing D′ is based on a known design choice value and is also known. Further, in the Use Stress Equation, the variables E and v refer the Young's Modulus and the Poissons ratio of the particular subject matter and are known material properties of the substrate. Therefore, the Young's Modulus E and the Poissons ratio v of the substrate are also known variables.

Referring back to the Stress Relationship, the proof stress σ_{Bend}^{PPproof} is the bend stress exhibited in the substrate during proof testing. It will be appreciated that, because the purpose of proof testing is to demonstrate fitness of the subject to operate under conditions that simulate (at least) actual end use conditions, the bend stress exhibited in the substrate during proof testing (i.e., σ_{Bend}^{PPproof}) may be larger than the bend stress that the substrate is designed to experience during use (i.e., σ_{Bend}^{PPuse}) to ensure the substrate is suitable for its intended purpose. The proof stress σ_{Bend}^{PPproof} may be calculated with the following equation, which is referred to as the “Proof Stress Equation”:

$${σ}_{Bend}^{PPproof} = \frac{1.198 E}{1 - {v}^{2}} ( \frac{h}{D - h} )$$

In the Proof Stress Equation, the thickness h of the substrate, as well as the Young's Modulus E and the Poissons ratio v of the substrate the same as utilized in the Use Stress Equation and, therefore are known variables. However, the variable D is the parallel plate spacing between the first plate and the second plate that bends the substrate at a radius at which the substrate is desired to be proof tested. As mentioned above, because it is desirable that the substrate be subjected to higher stresses during proof testing than during actual end use, the parallel plate spacing D in the Proof Stress Equation will be smaller than the parallel plate spacing D′ in the Use Stress Equation (i.e., D<D′), as decreasing the spacing between the parallel plates will result in a smaller bend radius and larger stress. The parallel plate spacing D in the Proof Stress Equation is the desired spacing between the first plate and the second plate that can be solved for using the Stress Relationship, the Use Stress Equation, and the Proof Stress Equation. Accordingly, the radius at which the substrate is bent during proof testing and/or the desired spacing between the first plate and the second plate that creates such desired radius in the substrate during proof test may be determined based on the material properties of the substrate (i.e., the Young's Modulus E and the Poissons ratio v of the substrate) and based on design parameters of the substrate (i.e., the thickness h of the substrate and the parallel plate spacing D′).

In embodiments, the Stress Relationship, the Use Stress Equation, and the Proof Stress Equation are stored in the memory of the HMI 126 and executed by the controller of the HMI 126. In these embodiments, the controller causes prompts to be displayed on the display 128 asking the test operator in input the variables utilized to solve for the parallel plate spacing D in the Proof Stress Equation. For example, prompts will appear on the display 128 asking the test operator to input values for the Young's Modulus E of the substrate, the Poissons ratio v of the substrate, the thickness h of the substrate, and the parallel plate spacing D′ that simulates actual end use of the substrate. Moreover, the test operator may input other test parameters or information into the HMI 126 as previously described, such as the amount of vertical translation of the second plate parallel to and relative to the first plate, the number of cycles for vertically translating the second plate, etc.

From the above, it is to be appreciated that defined herein is a testing apparatus that includes a first plate and a second plate between which a substrate may be attached, wherein the first plate and the second plate are movable towards each other along a first axis to create a bend in a region of the substrate and then translatable relative to each other along a second axis that is perpendicular to the first axis to reposition the bend in the substrate to other regions of the substrate, thereby subjecting a larger area of the substrate to stresses associated with the bend. For example, when moving the first plate and the second plate together to form the bend in the substrate, the region of the substrate subjected to bending is approximately 2% to 5% of a length of the substrate; however, by further translating the first plate and/or the second plate relative to each other, the bend region of the substrate may shift along the length of the substrate such that up to about 80% of the substrate may be subjected to bending. Thus, a longer or larger portion of the substrate may be exposed to the desired stress, thereby enhancing the ability to find flaws or defects in the substrate.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. An apparatus for proof-testing a substrate, the apparatus comprising:
a base;
a first plate coupled to the base, the first plate being movable relative to the base along a first axis and defining a first substrate face that is oriented perpendicular to the first axis;
a second plate coupled to the base, the second plate being movable relative to the base and relative to the first plate along a second axis that is perpendicular to the first axis, the second plate defining a second substrate face that is parallel to the first substrate face;
a first actuator operable to move the first plate along the first axis towards or away from the second plate;
a second actuator operable to move the second plate along the second axis relative to the first plate; and
a controller operatively connected to the first actuator and the second actuator, wherein the controller is operable to control movement of the first plate along the first axis and to control movement of the second plate along the second axis.

2. The apparatus of claim 1, further comprising a first sensor connected to the controller for monitoring a position of the first plate along the first axis relative to the second plate.

3. The apparatus of claim 2, wherein the first sensor is a first linear encoder.

4. The apparatus of claim 1, further comprising a second sensor connected to the controller for monitoring a position of the second plate along the second axis relative to the first plate.

5. The apparatus of claim 4, wherein the second sensor is a second linear encoder.

6. The apparatus of claim 1, further comprising:
a plurality of openings in the first substrate face of the first plate;
a plurality of openings in the second substrate face of the second plate; and
a vacuum pump operably connected to the first plate and the second plate, wherein the vacuum pump is operable to apply vacuum pressure at the plurality of openings in the first substrate face of the first plate and the plurality of openings in the second substrate face of the second plate.

7. The apparatus of claim 1, wherein the first plate and the second plate each include a lower side and an upper side that is positioned farther from the base than the lower side, the first substrate face of the first plate and the second substrate face of the second plate each extending between the lower side and the upper side thereof, and wherein registration marks are provided on the upper side of the first plate and on the upper side of the second plate.

8. The apparatus of claim 1, wherein the first plate and the second plate each include a lower side and an upper side that is positioned farther from the base than the lower side, the first substrate face of the first plate and the second substrate face of the second plate each extending between the lower side and the upper side thereof, wherein a first clamp is provided on the upper side of the first plate and a second clamp is provided on the upper side of the second plate.

9. The apparatus of claim 1, further comprising an acoustic sensor operably connected to the controller and operable to detect sound associated with a failure of the substrate, and a camera operably connected to the controller and operable capture an image of the failure of the substrate, wherein the controller is operable to cease operation of the first actuator and the second actuator upon detection of the failure of the substrate.

10. The apparatus of claim 1, further comprising a first sacrificial film removably disposed on the first substrate face of the first plate and a second sacrificial film removably disposed on the second substrate face of the second plate.

11. An apparatus for testing a substrate, comprising:
a base;
a first plate coupled to the base, the first plate being movable relative to the base along a first axis and along a second axis that is perpendicular to the first axis, the first plate defining a first substrate face that is oriented perpendicular to the first axis;
a second plate coupled to the base, the second plate being movable relative to the base and relative to the first plate along the first axis and along a third axis that is parallel to the second axis, the second plate defining a second substrate face that is parallel to the first substrate face;
a first actuator operable to move the first plate along the first axis towards or away from the second plate;
a second actuator operable to move the first plate along the second axis relative to the second plate;
a third actuator operable to move the second plate along the first axis towards or away from the first plate;
a fourth actuator operable to move the second plate along the third axis relative to the second plate; and
a human machine interface, the human machine interface comprising a controller and a display, wherein the controller is operatively connected to the first actuator, the second actuator, the third actuator, and the fourth actuator to control movement of the first plate along the first axis and the second axis and to control movement of the second plate along the first axis and the third axis.

12. The apparatus of claim 11, further comprising a plurality of openings in the first substrate face and in the second substrate face and a vacuum pump operably connected to the first plate and the second plate, wherein the vacuum pump is operable to apply vacuum pressure at the plurality of openings.

13. The apparatus of claim 12, wherein:
the first substrate face comprises a central channel associated with each opening formed therein, each of the central channels being in communication with the opening associated therewith and having a plurality of grooves extending therefrom, each of the grooves and each of the plurality of grooves being formed in the first substrate face such that vacuum pressure supplied by the opening is applied to the central channel and the plurality of grooves to thereby retain a first end of the substrate when covering the central channel and the plurality of grooves; and
the second substrate face comprises a central channel associated with each opening formed therein, each of the central channels being in communication with the opening associated therewith and having a plurality of grooves extending therefrom, each of the grooves and each of the plurality of grooves being formed in the second substrate face such that vacuum pressure supplied by the opening is applied to the central channel and the plurality of grooves to thereby retain a second end of the substrate when covering the central channel and the plurality of grooves.

14. The apparatus of claim 11, wherein the first plate and the second plate each include a lower side and an upper side that is positioned further from the base than the lower side, the first substrate face of the first plate and the second substrate face of the second plate each extending between the lower side and the upper side thereof, and wherein registration marks are provided on the upper side of the first plate and on the upper side of the second plate.

15. The apparatus of claim 11, wherein the first plate and the second plate each include a lower side and an upper side that is positioned further from the base than the lower side, the first substrate face of the first plate and the second substrate face of the second plate each extending between the lower side and the upper side thereof, and a first clamp is provided on the upper side of the first plate and a second clamp is provided on the upper side of the second plate.

16. The apparatus of claim 11, further comprising an acoustic sensor operably connected to the controller and operable to detect sound associated with a failure of the substrate.

17. The apparatus of claim 16, further comprising a camera operably connected to the controller and operable to capture an image of the failure of the substrate.

18. The apparatus of claim 17, wherein the controller is operable to record the image of the failure of the substrate upon detecting the failure via the acoustic sensor.

19. The apparatus of claim 18, wherein the first plate and the second plate each include a lower side and an upper side that is positioned further from the base than the lower side, the first substrate face of the first plate and the second substrate face of the second plate each extending between the lower side and the upper side thereof, and at least one scale feature disposed on either or both of the first plate and the second plate, the at least one scale feature having a known dimension and positioned in view of the camera.

20. The apparatus of claim 11, further comprising a first sacrificial film removably disposed on the first substrate face of the first plate and a second sacrificial film removably disposed on the second substrate face of the second plate.

21. A method of testing a substrate, comprising:
attaching a first end of the substrate to a first plate and a second end of the substrate to a second plate, wherein the first plate and the second plate are parallel;
moving, via a first actuator, the first plate along a first axis from a first default position towards the second plate into a first testing position, where a first substrate face of the first plate is positioned at a first desired spacing from a second substrate face of the second plate, wherein the first desired spacing is at least partially based on material properties of the substrate and design parameters of the substrate; and
translating, via a second actuator, the second plate relative to the first plate along a second axis that is perpendicular to the first axis from a second default position.

22. The method of claim 21, further comprising calculating the first desired spacing based at least on material properties of the substrate and design parameters of the substrate.

23. The method of claim 21, wherein the moving the second plate comprises moving the second plate a prescribed distance in a first direction from the second default position, returning the second plate to the second default position, continue moving the second plate the prescribed distance from the second default position along the second axis in a second direction where the second direction is opposite the first direction, and returning the second plate to the second default position.

24. The method of claim 21, further comprising:
returning the first plate, via the first actuator, to the first default position; and
returning the second plate, via the second actuator, to the second default position.

25. The method of claim 21, further comprising:
translating, via a third actuator, the first plate relative to the second plate along a third axis that is parallel to the second axis as the second plate is translated along the second axis, wherein the first plate is translated along the third axis in an opposite direction as the second plate and at an equal speed as the second plate.
